(19) United States
(12) Patent Application Publication
(10) Pub. No.: US 2011/0265129 A1
(43) Pub. Date: Oct. 27, 2011

(54) METHOD AND APPARATUS FOR TRANSMITTING ETHERNET DATA THROUGH AUDIO/VIDEO INTERFACE

(75) Inventors: Il-ju NA, Yongin-si (KR); Jae-min LEE, Suwon-si (KR); Harkirat SINGH, Santa Clara, CA (US)

(73) Assignee: SAMSUNG ELECTRONICS CO., LTD., Suwon-si (KR)

(21) Appl. No.: 13/094,170

(22) Filed: Apr. 26, 2011

Related U.S. Application Data
(60) Provisional application No. 61/327,783, filed on Apr. 26, 2010.

(30) Foreign Application Priority Data
Mar. 9, 2011 (KR) 10-2011-0021044

(51) Int. Cl. H04N 7/18

(52) U.S. Cl. 725/80

(57) ABSTRACT

Provided are methods and apparatuses for transmitting and receiving data between a device of an audio/video (AV) network and a device of an Ethernet network by using correspondence between an AV network address and a medium access control (MAC) address. A method of transmitting data to a second device by using a first device includes: generating a transmission unit of a second type network in which a second type network address of the second device is set as a destination address; generating a transmission unit of a first type network including the generated transmission unit of the second type network by setting a first type network address of a third device, corresponding to the second type network address of the second device, as a destination address; and transmitting the generated transmission unit of the first type network to the third device.

### CROSS-REFERENCE TO RELATED PATENT APPLICATIONS

This application claims the benefit of U.S. Provisional Application No. 61/327,783, filed on Apr. 26, 2010 in the United States Patent and Trademark Office, and claims priority from Korean Patent Application No. 10-2011-0021044, filed on Mar. 9, 2011 in the Korean Intellectual Property Office, the disclosures of which are incorporated herein in their entireties by reference.

### BACKGROUND

1. Field

Apparatuses and methods consistent with exemplary embodiments relate to transmitting and receiving data based on an audio/video (AV) interface, and more particularly, to transmitting and receiving Ethernet data based on an AV interface.

2. Description of the Related Art

A source device for providing audio/video (AV) data and a sink device for receiving AV data from the source device and reproducing the AV data are connected to each other through a predetermined AV interface.

For example, the source device and the sink device may be connected to each other through an AV interface such as digital video/visual interface (DVI) or high-definition multimedia interface (HDMI) for transmission of digital AV data.

### SUMMARY

Aspects of one or more exemplary embodiments provide a method and apparatus for transmitting and receiving Ethernet data in a network established based on an audio/video (AV) interface.

Aspects of one or more exemplary embodiments also provide a computer-readable recording medium having recorded thereon a program for executing the method according to the present invention.

According to an aspect of an exemplary embodiment, there is provided a method of transmitting data to a second device by using a first device, the method including: generating a transmission unit of a second type network in which a second type network address of the second device is set as a destination address; generating a transmission unit of a first type network including the transmission unit of the second type network by setting a first type network address corresponding to the second type network address of the second device as a destination address; and transmitting the transmission unit of the first type network to a third device corresponding to the first type network address, wherein the third device transmits the transmission unit of the second type network to the second device corresponding to the second type network address.

The first type network may include an audio/video (AV) network connected via a link that is capable of performing bidirectional transmission of AV data, and the second type network may include an Ethernet network.

According to an aspect of another exemplary embodiment, there is provided a method of transmitting data to a first device by using a second device, the method including: generating a transmission unit of a second type network in which a second type network address of the first device is set as a destination address; and transmitting the transmission unit of the second type network to a third device corresponding to the second type network address of the first device, wherein the third device generates the transmission unit of first type network including the transmission unit of the second type network by setting a first type network address corresponding to the second type network address of the first device as a destination address and transmits the transmission unit of the first type network to the first device corresponding to the first type network address.

According to an aspect of another exemplary embodiment, there is provided a method of relaying data by using a third device, the method including: receiving, from a first device, a transmission unit of a first type network which includes a transmission unit of a second type network in which a second type network address of a second device is set as a destination address and in which a first type network address of the third device is set as a destination address; determining a port of the second type network to which the second type network address is mapped; and transmitting the transmission unit of the second type network to the second device through the port of the second type network.

According to an aspect of another exemplary embodiment, there is provided a method of relaying data by using a third device, the method including: receiving, from a second device, a transmission unit of a second type network in which a second type network address of a first device is set as a destination address; determining a port of a first type network to which the second type network address of the first device is mapped; generating a transmission unit of the first type network in which a first type network address of the first device corresponding to the second type network address of the first device is set as a destination address and which includes the received transmission unit of the second type network; and transmitting the transmission unit of the first type network to the first device through the port of the first type network.

According to an aspect of another exemplary embodiment, there is provided an apparatus for transmitting data to a second device by using a first device, the apparatus including: a host unit generating a transmission unit of a second type network in which a second type network address of the second device is set as a destination address; and a port unit generating a transmission unit of a first type network including the transmission unit of the second type network by setting a first type network address corresponding to the second type network address of the second device as a destination address and transmitting the transmission unit of the first type network to a third device corresponding to the first type network address, wherein the third device transmits the transmission unit of the second type network to the second device corresponding to the second type network address.

According to an aspect of another exemplary embodiment, there is provided an apparatus for transmitting data to a first device by using a second device, the apparatus including: a host unit generating a transmission unit of a second type network in which a second type network address of the first device is set as a destination address; and a port unit transmitting the transmission unit of the second type network to a third device corresponding to the second type network address of the first device, wherein the third device generates the transmission unit of the first type network including the transmission unit of the second type network by setting a first type network address corresponding to the second type network address of the first device as a destination address and transmits the transmission unit of the first type network to the first device corresponding to the first type network address.

According to an aspect of another exemplary embodiment, there is provided an apparatus for relaying data by using a third device, the apparatus including: a first port unit receiving, from a first device, a transmission unit of a first type network which includes a transmission unit of a second type network in which a second type network address of a second device is set as a destination address and in which a first type network address of the third device is set as a destination address; a switch unit determining a port of the second type network to which the second type network address is mapped; and a second port unit transmitting the transmission unit of the second type network to the second device through the port of the second type network.

According to an aspect of another exemplary embodiment, there is provided an apparatus for relaying data by using a third device, the apparatus including: a second port unit receiving, from a second device, a transmission unit of a second type network in which a second type network address of a first device is set as a destination address; a switch unit determining a port of the first type network to which the second type network address of the first device is mapped; and a first port unit generating a transmission unit of the first type network in which the first type network address of the first device corresponding to a second type network address of the first device is set as a destination address and which includes the transmission unit of the second type network and transmitting the transmission unit of the first type network to the first device through the port of the first type network.

According to an aspect of another exemplary embodiment, there is provided a computer-readable recording medium having recorded thereon a program for executing the method of transmitting data and/or the method of relaying data.

### BRIEF DESCRIPTION OF THE DRAWINGS

The above and other features and advantages will become more apparent by describing in detail exemplary embodiments with reference to the attached drawings in which:

FIG. 1 is a diagram of a network topology of devices connected to one another through an audio/video (AV) interface, according to an exemplary embodiment;

FIG. 2A is a diagram of bidirectional data transmission through an AV interface, according to an exemplary embodiment;

FIG. 2B is a diagram of bidirectional data transmission through an AV interface, according to another exemplary embodiment;

FIG. 3 is a block diagram of a layer structure of a network based on an AV interface, according to an exemplary embodiment;

FIG. 4 is a diagram of devices included in different types of networks, according to an exemplary embodiment;

FIG. 5 is a diagram of a switch according to an exemplary embodiment;

FIG. 6 is a diagram of a transmission unit of a network based on an AV interface, according to an exemplary embodiment;

FIGS. 7A through 7G are tables showing information about devices connected to ports, according to an exemplary embodiment;

FIG. 8 is a block diagram of an apparatus for transmitting data, according to an exemplary embodiment;

FIG. 9 is a block diagram of an apparatus for relaying data, according to an exemplary embodiment;

FIG. 10 is a flowchart illustrating a method of transmitting data, according to an exemplary embodiment;

FIG. 11 is a flowchart illustrating a method of transmitting data, according to another exemplary embodiment;

FIG. 12 is a flowchart illustrating a method of relaying data, according to an exemplary embodiment; and

FIG. 13 is a flowchart illustrating a method of relaying data, according to another exemplary embodiment.

### DETAILED DESCRIPTION OF EXEMPLARY EMBODIMENTS

Exemplary embodiments will now be described more fully with reference to the accompanying drawings.

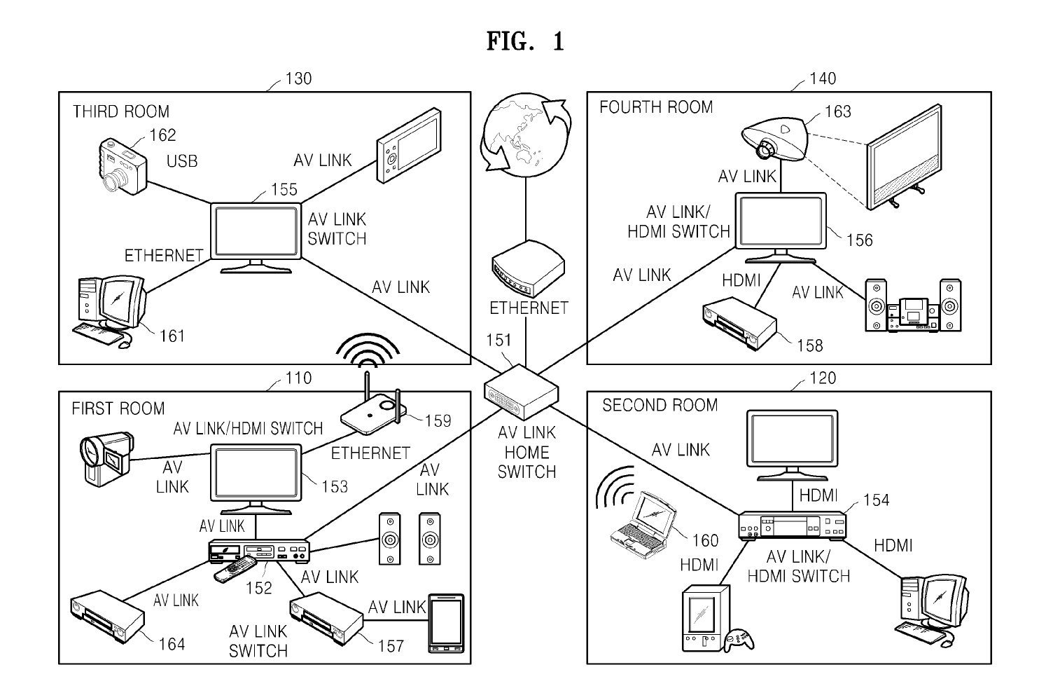

FIG. 1 is a diagram of a network topology of devices connected to one another through an audio/video (AV) interface, according to an exemplary embodiment. The AV interface is an interface for transmitting and receiving AV data. An ‘AV link’ is established based on the AV interface according to an exemplary embodiment, and a high-definition multimedia interface (HDMI) is a connection via an HDMI cable.

Referring to FIG. 1, AV devices may establish networks through the AV interface according to an exemplary embodiment. The AV devices disposed in a plurality of rooms may be connected to various types of AV devices disposed in rooms that are the same as or different from the plurality of rooms through the AV interface according to the present exemplary embodiment. In this regard, a switch device for relaying an AV link relays a connection based on the AV interface. The switch device may be a separate device for relaying an AV link, such as an AV link home switch 151 or AV devices, namely, an AV receiver 152, a TV 153, a switch device 154, a TV 155, a TV 156, or a Blu-ray player 157 each having a switch function. In a first room 110, an AV receiver 152, a TV 153, and a Blu-ray player 157 that are each an AV device act as a switch device, and in a third room 130 and a fourth room 140, TVs 155 and 156 that are each an AV device act as a switch device.

In addition, the switch device may be a device for switching the AV interface according to the present exemplary embodiment and the HDMI. For example, a switch device 154 in a second room 120 may receive AV data from a computer and a game station through the HDMI and may transmit the received AV data to devices disposed in at least one of the first room 110, the third room 130, and the fourth room 140 through the AV link according to the present exemplary embodiment.

The devices of a network shown in FIG. 1 may be classified into a source/leaf device, a source/switch device, a switch device, a sink/switch device, and a sink/leaf device according to their roles.

A device for providing the AV data without relaying the AV link, such as a set-top box (STB) 164 in the first room 110, corresponds to the source/leaf device, and a device for providing the AV data to another device and relaying the AV link, such as the Blu-ray player 157 in the first room 110, corresponds to the source/switch device. In addition, a device for performing only relaying of the AV link, such as the AV link home switch 151, corresponds to the switch device, and a device for receiving the AV data from another device and relaying the AV link, such as the TV 156 in the fourth room 140, corresponds to the sink/switch device. Lastly, a device for receiving the AV data from another device without relaying the AV link, such as a projector 163 in the fourth room 140, corresponds to the sink/leaf device.

According to the network structure of FIG. 1, AV data output from the Blu-ray player 157 in the first room 110 may be transmitted to the TV 155 in the third room 130 or the TV 156 in the fourth room 140 through the AV receiver 152 and the AV link home switch 151. In addition, a broadcasting signal received by an STB 158 in the fourth room 140 may be transmitted to the TV 155 in the third room 130 through the AV link home switch 151 and to the TV 153 in the first room 110 through the AV link home switch 151 and the AV receiver 152.

In other words, in order to freely transmit and receive the AV data in a network based on the AV interface (hereinafter, referred to as an ‘AV network’), as illustrated in FIG. 1, the AV interface according to the present exemplary embodiment supports bidirectional data transmission.

An AV interface according to the related art, such as a digital visual interface (DVI) or an HDMI, supports unidirectional data transmission from a source device to a sink device. AV data output from the source device is transmitted only to the sink device, and the sink device may not transmit the AV data to the source device through the AV interface according to the related art, such as the DVI or the HDMI. For example, the TV 156 that is a sink device in the fourth room 140 may receive the AV data from the STB 158 connected to the TV 156 via the HDMI and may not transmit the AV data to the STB 158 according to the related art.

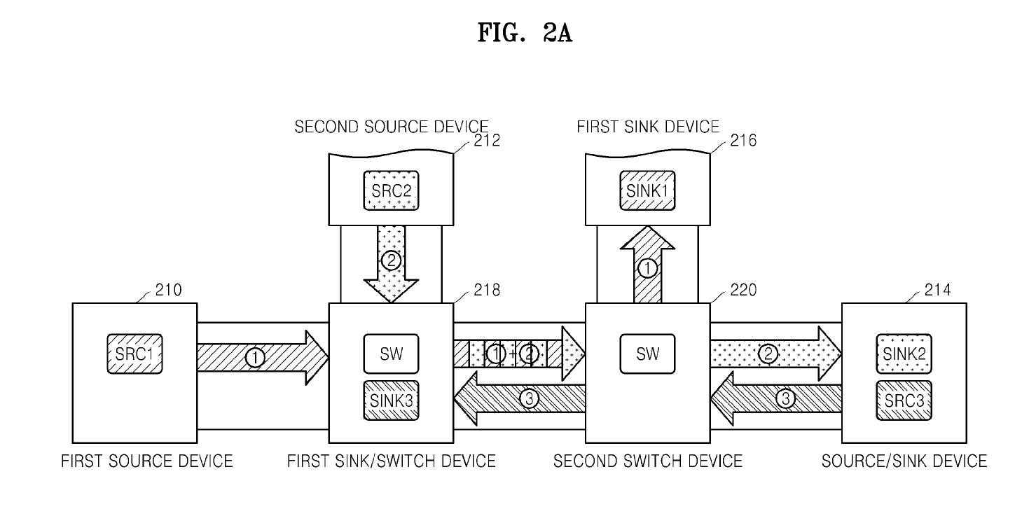

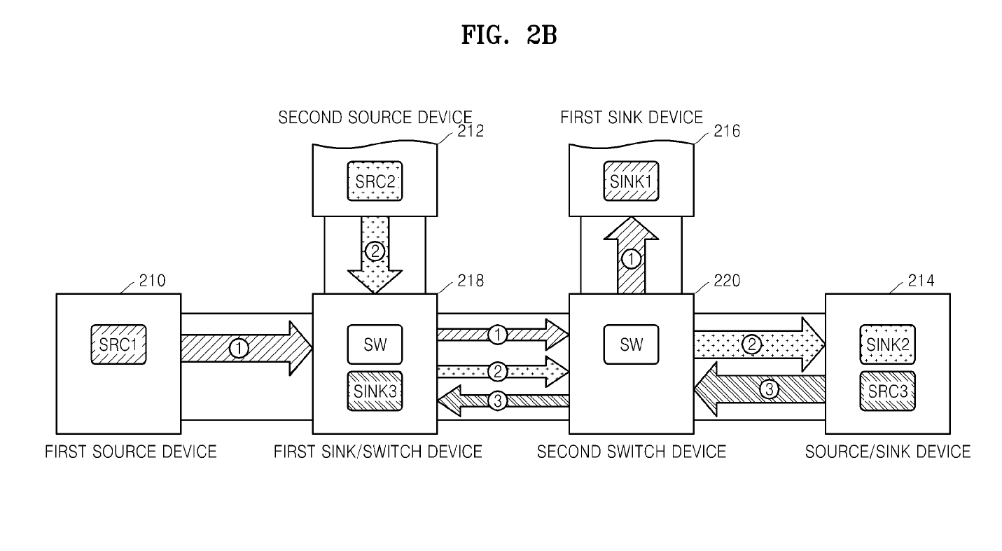

However, in the AV link through the AV interface according to the present exemplary embodiment, bidirectional data transmission may be supported, and data may be transmitted to a device in another room in the network structure of FIG. 1, and data may be received from the device in another room. In particular, in the AV link according to the present exemplary embodiment, bidirectional transmission of uncompressed video data may be performed. Thus, bidirectional data transmission will now be described below with reference to FIGS. 2A and 2B in detail.

FIG. 2A is a diagram of bidirectional data transmission through an AV interface, according to an exemplary embodiment.

Referring to FIG. 2A, AV data, for example, uncompressed video data output from a first source device 210, for example, a Blu-ray player, may be reproduced by a first sink device 216, for example, a projector, and AV data output from a second source device 212, for example, an STB, may be reproduced by a source/sink device 214, for example, a personal computer (PC), and AV data output from the source/sink device 214 may be reproduced by a first sink/switch device 218, for example, a TV.

In this case, the first sink/switch device 218 receives the AV data output from the first source device 210 and the AV data output from the second source device 212 and performs time division duplex on the received AV data and transmits the time division duplexed-AV data to a second switch device 220.

The second switch device 220 that receives the AV data output from the first source device 210 and the AV data output from the second source device 212 relays the received data to transmit the AV data output from the first source device 210 to the first sink device 216 and to transmit the AV data output from the second source device 212 to the source/sink device 214. In addition, the second switch device 220 receives the AV data from the source/sink device 214 and transmits the received AV data to the first sink/switch device 218.

In a link between the first sink/switch device 218 and the second switch device 220 and a link between the second switch device 220 and the source/sink device 214, AV data, i.e., uncompressed video data, is transmitted not in a unidirectional manner but in a bidirectional manner. Thus, when devices illustrated in FIG. 2A are respectively connected to one another via one AV interface cable, the AV interface may perform bidirectional data transmission via one cable and may transmit AV data received from a plurality of source devices by using time division duplex.

FIG. 2B is a diagram of bidirectional data transmission through an AV interface, according to another exemplary embodiment.

Referring to FIG. 2B, AV data, for example, uncompressed video data output from the first source device 210, for example, a Blu-ray player, may be reproduced by the first sink device 216, for example, a projector, and AV data output from the second source device 212, for example, an STB, may be produced by the source/sink device 214, for example, a PC, and AV data output from the source/sink device 214 may be reproduced by the first sink/switch device 218, for example, a TV.

FIG. 2A illustrates a method of transmitting and receiving data by using time division duplex, and FIG. 2B illustrates a method of transmitting and receiving data by using space division duplex. The AV link based on the AV interface according to the present exemplary embodiment may include a plurality of sub-links. In addition, the plurality of sub-links may correspond to a plurality of lanes indicating a physical connection between devices and spatially separated from one another. Thus, as illustrated in FIG. 2B, AV data may be transmitted and received by using space division duplex based on the plurality of sub-links.

For example, the first sink/switch device 218 of FIG. 2B may transmit AV data output from the first source device 210 and AV data output from the second source device 212 by using space division duplex using two sub-links. Similarly, AV data output from the source/sink device 214 may be received from the second switch device 220 by using another sub-link.

An AV interface according to the related art, such as a DVI or an HDMI, may not perform bidirectional transmission of AV data. Thus, a data transmission network may not be established using the AV interface, as illustrated in FIG. 1. However, since the AV interface according to the present exemplary embodiment may perform bidirectional data transmission via one cable, as illustrated in FIGS. 2A and 2B, a network in which various devices are connected to one another may be flexibly established.

Referring back to FIG. 1, various types of data, e.g., Ethernet data, universal serial bus (USB) data, etc., as well as AV data, may be transmitted and received through the AV interface according to the present exemplary embodiment. A case where a laptop 160 disposed in the second room 120 transmits Ethernet data to a PC 161 disposed in the third room 130 via a wireless router 159 installed in the first room 110 will now be described. Ethernet data is data generally transmitted via a transmission control protocol/Internet protocol (TCP/IP)-based LAN.

Since the AV interface according to the present exemplary embodiment supports bidirectional data transmission unlike the AV interface according to the related art, Ethernet data may be transmitted and received through the AV interface. Thus, the laptop 160 transmits the Ethernet data to the PC 161 via a network established with the AV link. To this end, the switch devices disposed in the network of FIG. 1 have an operation for relaying the Ethernet data. The Ethernet data is transmitted to the PC 161 from the wireless router 159 by switching of a link layer.

According to another exemplary embodiment, when USB data output from a camera 162 is transmitted to the laptop 160, the switch devices transmit the USB data to the laptop 160 by using a switch operation of the USB data. Since various types of data, as well as the AV data, are transmitted through the AV interface, various devices may access a network connected via the AV interface and may transmit and receive data freely. The switch devices relay the USB data by switching of a link layer.

In addition, data for controlling a device and a network may be transmitted and received through the AV interface according to the present exemplary embodiment. For example, a user may control the AV receiver 152 disposed in the same room as the first room 110 by using the TV 153 disposed in the first room 110. The user manipulates the TV 153 and transmits data for controlling the AV receiver 152 through the AV interface, thereby controlling the AV receiver 152. In addition, the user may control the TV 156 or the STB 158 disposed in another room 140 and accessing the network established using the AV interface, through the AV interface.

Since the data for controlling the network connected via the AV interface may be transmitted and received through the AV interface, data for managing a network, as well as for setting link, may be transmitted and received as data for controlling a network through the AV interface.

Since various types of data are transmitted and received through the AV interface, a transmission unit of the AV network may include information about the types of data. The information about the types of data may be included in a header in the transmission unit of the AV network.

In addition, power may also be supplied through the AV interface according to the present exemplary embodiment. For example, like a supply of power through a USB interface, predetermined power may be supplied to a mobile device through the AV link. By supplying power through the AV link, power used for charging or operating the mobile device is supplied.

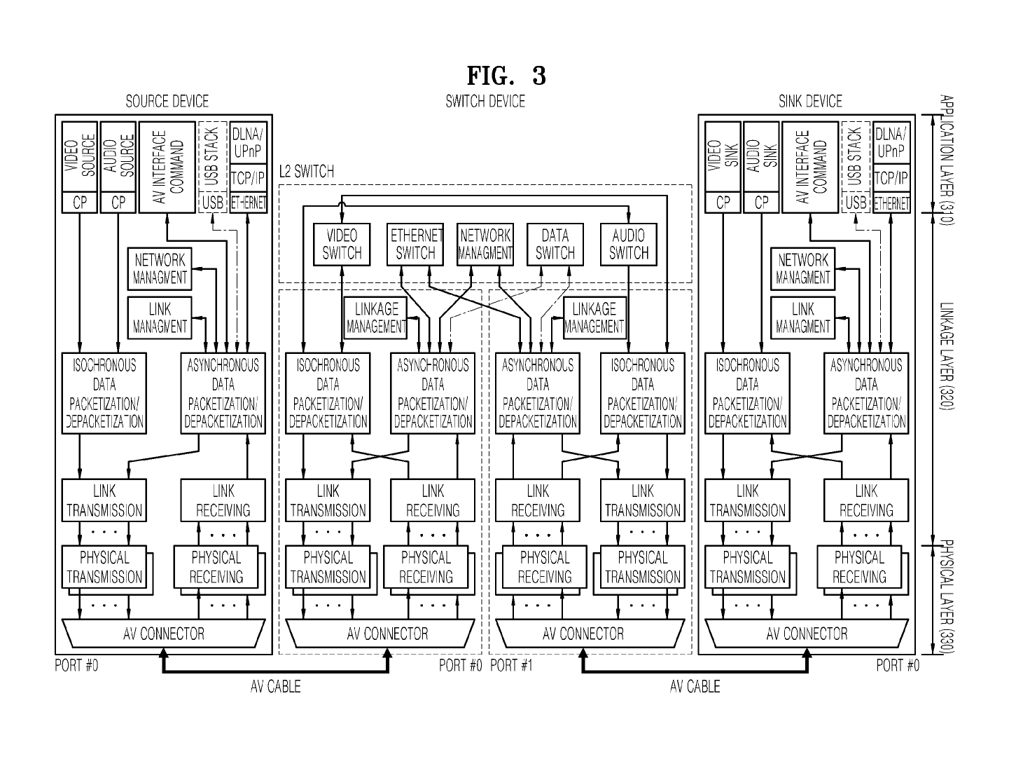

FIG. 3 is a block diagram of a layer structure of the network based on the AV interface, according to an exemplary embodiment.

In order to transmit various types of data based on the AV interface according to the present exemplary embodiment in a bidirectional manner as described above, a network layer structure as illustrated in FIG. 3 may be used.

Referring to FIG. 3, the network layer structure according to the present exemplary embodiment includes an application layer 310, a link layer 320, and a physical layer 310.

The application layer 310 includes sub-layers relating to processing of data transmitted and received through the above-described AV interface.

An application layer of a source device may include a video source layer for transmitting video data, an audio source layer for transmitting audio data, and a content protection (CP) layer for protecting the copyright of AV contents. In addition, the application layer of the source device may include an Ethernet layer relating to transmission of Ethernet data, a TCP/IP layer, and a Digital Living Network Alliance/Universal Plug and Play (DLNA/UPnP) layer. In addition, the application layer of the source device may include a USB stack relating to transmission of USB data and an AV interface command layer relating to control of the AV network.

Similarly, the application layer of a sink device may include a video sink layer for receiving video data, an audio sink layer for receiving audio data, and a CP layer for protecting the copyright of AV contents. In addition, the application layer of the sink device may include an Ethernet layer relating to receiving of Ethernet data, a TCP/IP layer, and a DLNA/UPnP layer. In addition, the application layer of the sink device may include a USB stack relating to transmission of USB data and an AV interface command layer relating to transmission of control data.

The link layer 320 provides an operation of transmitting data of the application layer 310 to a destination device. The link layer 320 includes an isochronous data packetization/depacketization layer for packetizing or depacketizing data that is to be transmitted in real-time, such as audio data or video data. In addition, the link layer 320 includes an asynchronous data packetization/depacketization layer for packetizing or depacketizing data that does not need to be transmitted in real-time, such as Ethernet data, USB data, or network control data. In addition, the link layer 320 includes a link management layer for managing an AV link and a network management layer for managing a network based on the AV link.

The switch device includes a video switch layer, an audio switch layer, an Ethernet switch layer, and a data switch layer so as to perform switching of the above-described link layer 320. The video switch layer and the audio switch layer determine a source address and a destination address of the link layer 320 based on the result of depacketization of the isochronous data packetization/depacketization layer. Similarly, the Ethernet switch layer and the data switch layer determine a source address and a destination address of the link layer 320 based on the result of depacketization of the asynchronous data packetization/depacketization layer.

The physical layer 330 converts data of the link layer 320 into a physical signal so as to transmit the data of the link layer 320 via a cable. The source device, the switch device, and the sink device include the physical layer 330. The physical layer 330 includes an AV connector, a physical transmission layer for transmitting data, and a physical receiving layer for receiving data.

The isochronous data packetization/depacketization layer or the asynchronous data packetization/depacketization layer of the link layer 320 may transmit packetized data to a link transmission layer, and the link transmission layer may multiplex the packetized data and may transmit the multiplexed data to the physical layer 310. As described above, the AV link according to the present exemplary embodiment may include a plurality of sub-links for space division duplex, and the AV cable may include a plurality of lanes corresponding to the plurality of sub-links and spatially separated from one another. Thus, the link transmission layer may multiplex the packetized data, may allocate the pieces of data to each of the lanes, and may transmit the multiplexed data to a plurality of physical transmission layers each corresponding to the plurality of lanes.

Furthermore, the pieces of data received by the plurality of physical receiving layers each corresponding to the plurality of lanes may be transmitted to a link receiving layer, and the link receiving layer may demultiplex the pieces of data received from the plurality of physical receiving layers and may transmit the demultiplexed data to the isochronous data packetization/depacketization layer or the asynchronous data packetization/depacketization layer. The isochronous data packetization/depacketization layer or the asynchronous data packetization/depacketization layer depacketizes the received data to transmit the depacketized data to the application layer 310 or the switch layers such as the video switch layer, the audio switch layer, the Ethernet switch layer, and the data switch layer.

Data transmitting and receiving according to the network layer structure illustrated in FIG. 3 is performed based on an address allocated to each device in the AV network. In order to identify devices connected to one another through the AV interface, a predetermined address is allocated to each device, and data transmitting and receiving is performed based on the address allocated to each device.

For example, when the AV receiver 152 disposed in the first room 110 of FIG. 1 transmits the AV data to the TV 156 disposed in the fourth room 140, the AV receiver 152 disposed in the first room 110 sets an address allocated to the AV receiver 152 in the AV network as a source address and sets an address allocated to the TV 156 as a destination address to generate a transmission unit. The generated transmission unit is a transmission unit of the AV network and is generated according to a protocol for defining an AV interface.

However, as described above, various types of data may be transmitted and received through the AV interface. For example, Ethernet data may be among the various types of data. In this case, the Ethernet data may not be transmitted to a correct destination device by using only the address of the AV network.

For example, when the AV receiver 152 disposed in the first room 110 transmits the Ethernet data to the PC 161 disposed in the third room 130, the PC 161 disposed in the third room 130 is not connected to the TV 155 through the AV interface and thus the address of the AV network is not allocated to the PC 161. Thus, the AV receiver 152 may not transmit the Ethernet data to the PC 161 based on only the address of the AV network. To this end, a method of transmitting data, according to an exemplary embodiment, uses information about a link layer address of the AV network and a link layer address of Ethernet mapped to a port of a device, which will now be described in detail with reference to the attached drawings.

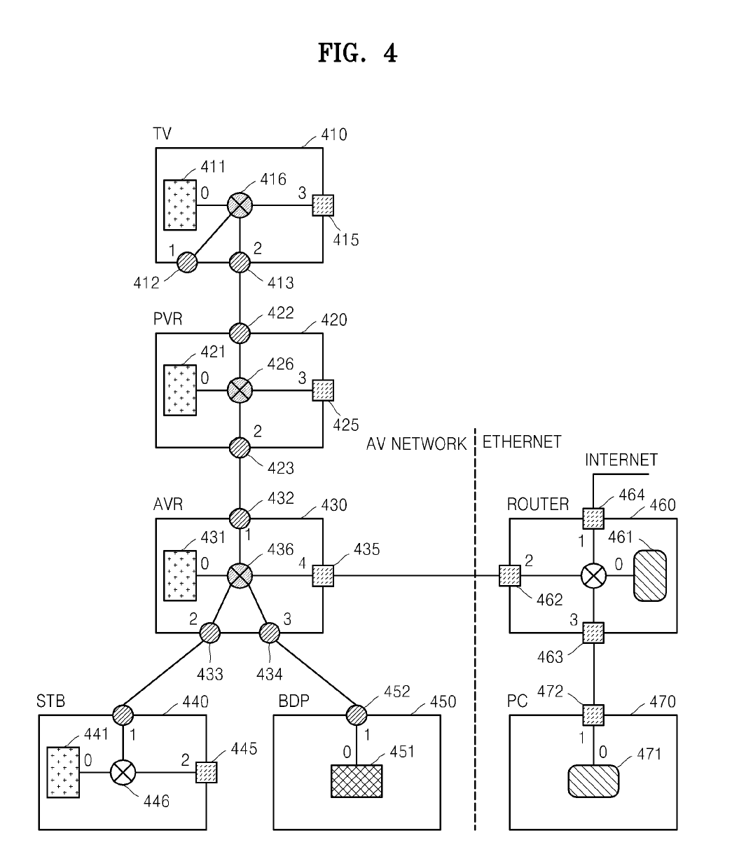

FIG. 4 is a diagram of devices included in different types of networks, according to an exemplary embodiment.

Referring to FIG. 4, a TV 410, a personal video recorder (PVR) 420, an AV receiver (AVR) 430, a STB 440, and a Blue-ray disc player (BDP) 450 are devices of the AV network that are connected to one another through the AV interface described above. An address of a link layer for identifying the devices in the AV network (hereinafter, referred to as “AV network addresses”) is allocated to the devices 410 through 450 connected to one another through the AV interface that is capable of bidirectional data communication according to the present exemplary embodiment. The video data, the audio data, the Ethernet data, the USB data, and the like are transmitted and received based on the AV network addresses.

In addition, since addresses of Ethernet link layers are used for generating, transmitting, and receiving the Ethernet data, medium access control (MAC) addresses, which are separate from the AV network addresses, are allocated to the devices for transmitting and receiving the Ethernet data. In FIG. 4, the TV 410, the PVR 420, the AVR 430, and the STB 440 are devices for transmitting and receiving the Ethernet data. Thus, the AV network addresses and the MAC addresses are allocated to hosts 411, 421, 431, and 441 of the devices. The BDP 450 is a device that is not capable of transmitting and receiving the Ethernet data. Accordingly, the MAC address may not be allocated to a host 451, which the AV network address is allocated to the host 451.

The MAC addresses may be inherent addresses respectively allocated to devices to be manufactured, and the AV network addresses may be addresses arbitrarily allocated in the AV network. It would be easily understood by one of ordinary skill in the art that the AV network addresses may be set to be the same as the MAC addresses in one or more exemplary embodiments.

The devices 410 through 450 of the AV network include ports 412, 413, 422, 423, 432, 433, 434, and 442 of the AV network for connecting the AV cable according to the present exemplary embodiments, and the devices 410, 420, 430, and 440 that are capable of transmitting and receiving the Ethernet data further include Ethernet ports 415, 425, 435, and 445 that can be directly connected to Ethernet network.

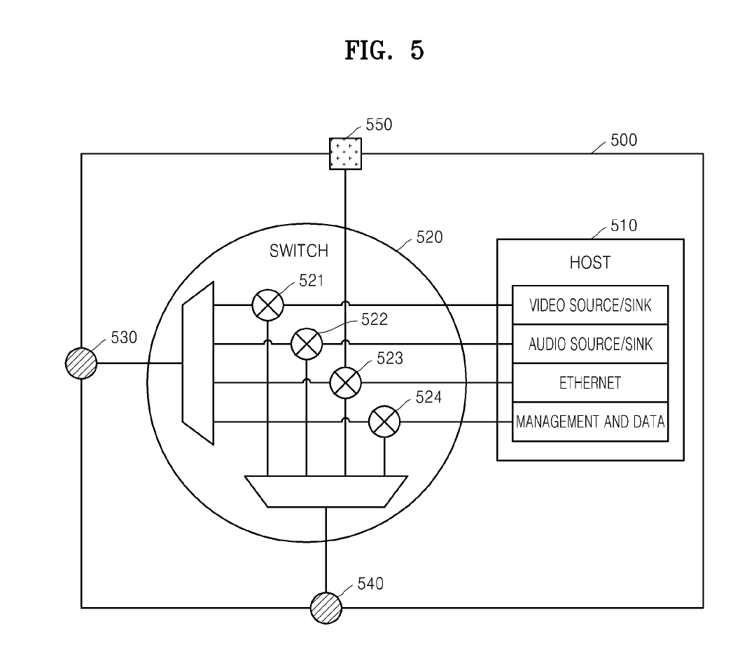

In addition, the TV 410, the PVR 420, the AVR 430, and the STB 440 each include switches 416, 426, 436, and 446 for switching of link layers described above with reference to FIG. 3. The switches 416, 426, 436, and 446 perform switching of AV data by referring to the AV network address. The switches 416, 426, 436, and 446 transmit the AV data to a port corresponding to a destination address by referring to a destination AV network address. When the type of data is Ethernet data, the switches 416, 426, 436, and 446 may perform switching of the Ethernet data by referring to the MAC address together with the AV network address. This will now be described in detail with reference to FIG. 5.

FIG. 5 is a diagram of a switch 520 according to an exemplary embodiment.

FIG. 5 illustrates a device 500 for performing switching in the AV network. The switch 520 of a device including a host 510, ports 530 and 540 of the AV network, and an Ethernet port 550 will now be described in detail.

Referring to FIG. 5, the switch 520 may perform switching of a link layer among the host 510, the ports 530 and 540 of the AV network, and the Ethernet ports 550. Switching of the link layer is performed by referring to an address of the link layer.

The switch 520 may include a switch 521 relating to video data, a switch 522 relating to audio data, a switch 523 relating to Ethernet data, and a switch 524 relating to data for controlling the AV network and USB data for controlling the AV network according to types of data.

In order to switch various types of data by using the plurality of switches 521 through 524, a multiplexer/demultiplexer may be connected to the ports 530 and 540 of the AV network.

When the device 500 receives data from another device, the switch 520 determines the type of the data by referring to a header in a transmission unit and performs switching by using the switch 521, 522, 523 or 524 according to the result of the determination. A basic unit for transmitting and receiving data is a transmission unit and may be a predetermined packet or frame divided by the header. This will now be described in detail.

(1) Switching of Data Received Through Port of AV Network

A transmission unit of the AV network is received through the port 530 or 540 of the AV network, and the received data is depacketized. A destination AV network address is detected according to the result of depacketization. When the types of the received data are video data, audio data, data for controlling the AV network or USB data, a port corresponding to the destination AV network address is determined by referring to the destination AV network address, and the received transmission unit of the AV network is transmitted to the determined port. When the destination AV network address is the AV network address allocated to the device 500, the received transmission unit is transmitted to the host 510. Since the AV network address of the host 510 is the AV network address of the device 500, the received transmission unit is transmitted to the host 510. The switch 521 relating to video data, the switch 522 relating to audio data, and the switch 524 relating to data for controlling the AV network and USB data perform switching according to the types of data.

Even when the type of the received data is Ethernet data, a port corresponding to the destination AV network address is determined by referring to the AV network address in the received transmission unit of the AV network, and the received transmission unit of the AV network is transmitted to the determined port. However, since the Ethernet data includes a destination MAC address as well as the destination AV network address, the port corresponding to the destination AV network address may be determined by referring to the destination MAC address.

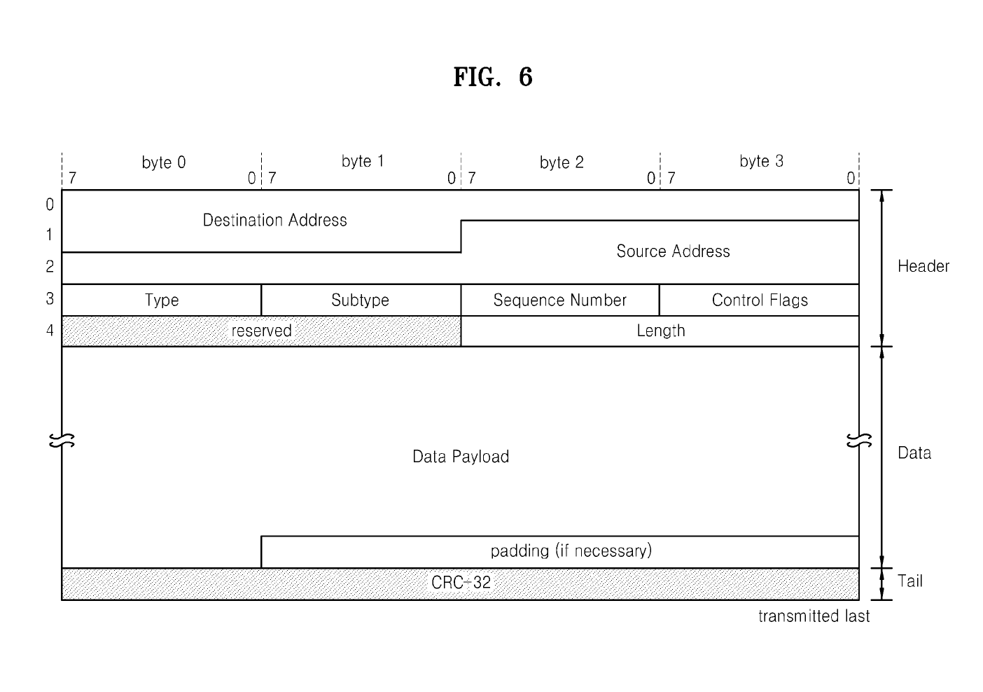

For example, when the destination AV network address is the same as the AV network address of the device 500, the destination MAC address may not be the same as a MAC address of the device 500. Since the destination MAC address and the MAC address of the device 500 are different from each other, the device 500 is not a device that receives the Ethernet data. Thus, the Ethernet data may be transmitted to an Ethernet port, for example, the Ethernet port 550 corresponding to the destination MAC address. The Ethernet data received through the port 530 or 540 of the AV network is a transmission unit of Ethernet, i.e., a transmission unit of the AV network including an Ethernet frame. Since the transmission unit that can be transmitted through the Ethernet port 550 is the Ethernet frame, only the Ethernet frame from the transmission unit of the AV network received through the port 530 or 540 of the AV network may be transmitted to the Ethernet port 550. This will now be described in detail with reference to FIG. 6.

FIG. 6 is a diagram of a transmission unit of a network based on an AV interface, according to an exemplary embodiment.

Referring to FIG. 6, a portion “Header” in the transmission unit of the AV network includes a field “Destination Address” as a destination AV network address and includes a field “Source Address” as a source AV network address. A field “Type” defines the types of data transmitted and received through the AV interface. A portion “data” in the transmission unit of the AV network includes actually-transmitted data. When the transmission unit is a transmission unit relating to Ethernet data, the Ethernet frame according to TCP/IP is included in a field “Data Payload”.

Thus, a portion that can be actually transmitted through the Ethernet port 550 from the transmission unit of the AV network received through the port 530 or 540 of the AV network is only a portion “Data Payload”. Thus, the switch 520 may transmit only the transmission unit of Ethernet included in the transmission unit of the AV network to the Ethernet port 550.

(2) Switching of Data Received Through Ethernet Port

The Ethernet frame is received through the Ethernet port 550, and the received frame is transmitted to a port corresponding to a destination MAC address by referring to the destination MAC address included in the received Ethernet frame. Switching is performed using the switch 530 relating to the Ethernet data, and when the destination MAC address is the same as a MAC address of a host, the received Ethernet frame is transmitted to the host.

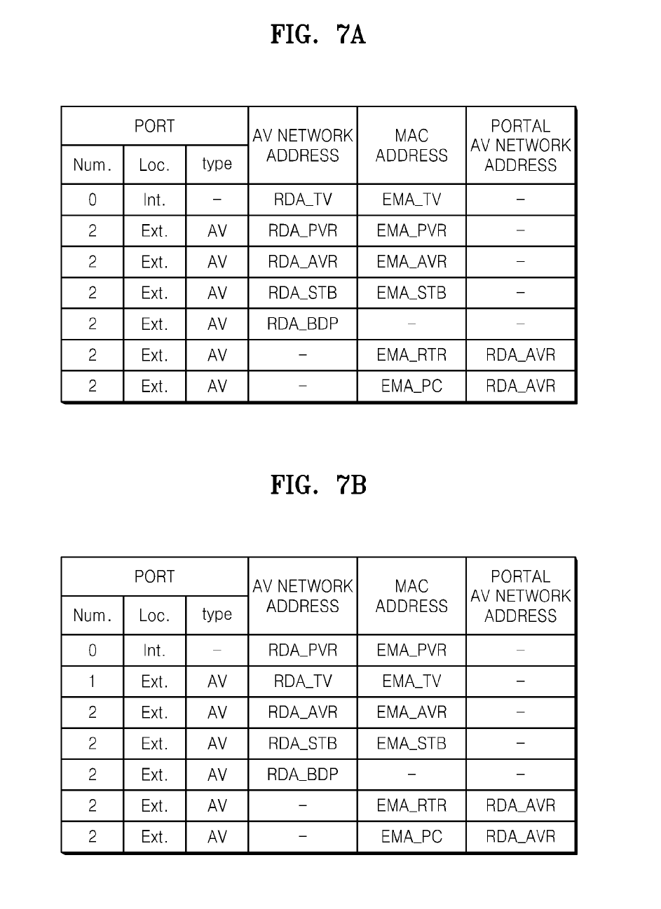

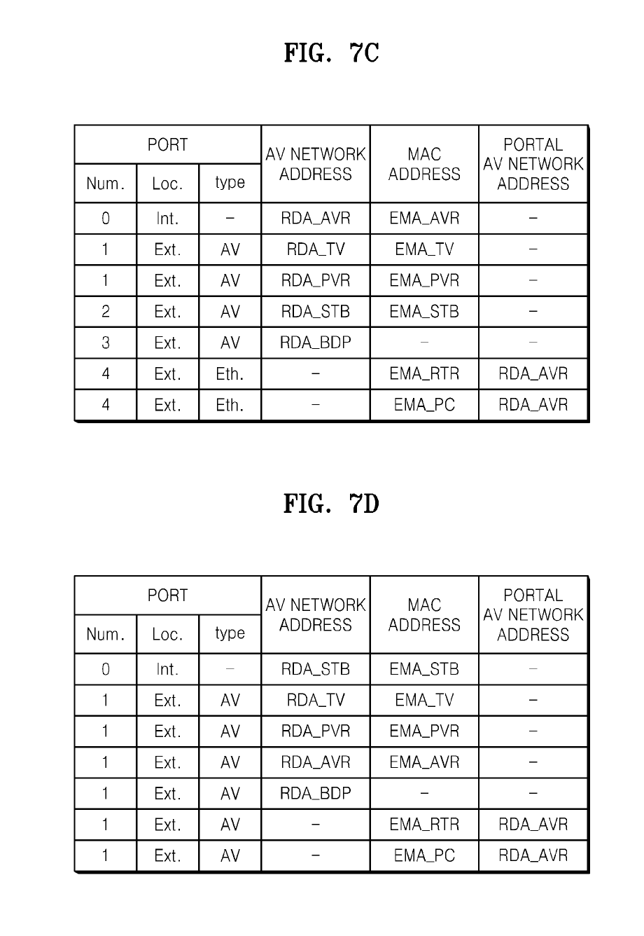

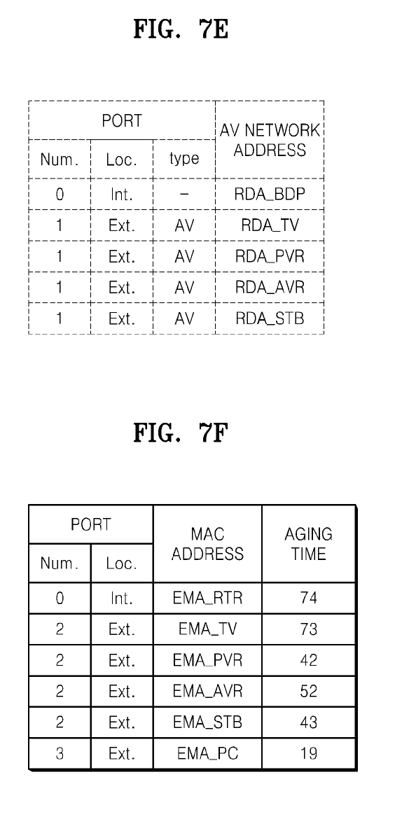

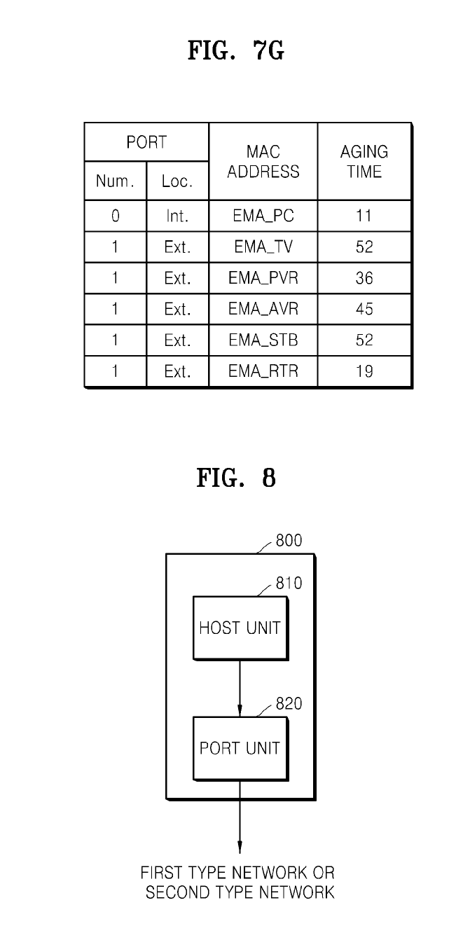

When the destination MAC address is different from the MAC address of the host, a port of the AV network corresponding to the destination MAC address is determined. As described above, the MAC address, as well as an AV network address, may be allocated to devices of the AV network. Thus, the port of the AV network may include a port to which a device corresponding to the destination MAC address is connected. Thus, the switch 520 determines the port of the AV network to which the device corresponding to the destination MAC address is connected and transmits the Ethernet frame to the determined port. Information to be referred to so as to determine the port of the AV network corresponding to the destination MAC address will be described below with reference to FIGS. 7A through 7G.

(3) Switching of Data Transmitted by Host Through Port of AV Network

The host 510 may transmit at least one of video data, audio data, Ethernet data, data for controlling the AV network, USB data, and the like to another device of the AV network. When the host 510 generates predetermined data and transmits the data to the switch 520, the switch 520 switches the received data by using a switch 521, 522, 523, or 524 corresponding to the types of the received data. A port corresponding to a destination AV network address is determined, and the received pieces of data are transmitted to the determined port.

(4) Switching of Data Transmitted by Host Through Ethernet Port

The host 510 may transmit the Ethernet data to another Ethernet device that is not in the AV network. When the host 510 generates the Ethernet data and transmits the generated Ethernet data to the switch 520, the switch 520 switches the received data by using the switch 523 relating to the Ethernet data. The Ethernet port 550 corresponding to the destination MAC address is determined, and the Ethernet data is transmitted to the determined Ethernet port 550.

Referring back to FIG. 4, the devices 410 through 450 of the AV network include the switches 416, 426, 436, and 446. The switches 416, 426, 436, and 446 perform switching of data, thereby transmitting or receiving the transmission unit of the AV network. However, a MAC address, as well as an AV network address, are referred to so as to transmit the Ethernet data as described above with reference to FIG. 5.

For example, when the TV 410 of the AV network transmits the Ethernet data to the PC 470 of Ethernet type, the switches refer to the MAC address as well as the AV network address. This is because each of the devices 460 and 470 of Ethernet type includes only the Ethernet ports 462, 463, and 472 and the AV network address is not allocated to the hosts 461 and 471.

Thus, each of the devices 410 through 450 of the AV network retains information about devices connected through ports of the AV network and Ethernet ports, and the information is shared between the devices 410 through 450 of the AV network. The information about the devices connected to the ports of the AV network include AV network addresses and MAC addresses of devices that may access the AV network through the port of the AV network, and information about devices connected to the Ethernet ports include MAC addresses of devices that may access Ethernet through the Ethernet ports. This will now be described with reference to FIGS. 7A through 7G.

FIGS. 7A through 7G are tables showing information about devices connected to ports, according to an embodiment of the present invention.

FIG. 7A illustrates information about devices connected to ports of the TV 410.

Referring to FIG. 7A, a table in which AV network addresses and MAC addresses are mapped to the ports of the TV 410 is shown. A port having the number 0 is an internal port, and the host 411 is connected to the port having the number 0. The port having the number 0 is set as “Int.” in order to indicate that “Loc.” indicating an external port or an internal port is an internal port, and an AV network address RDA_TV and a MAC address EMA_TV of the host 411 are mapped to the port having the number 0.

A port having the number 2 is an external port and is a port of the AV network. Thus, the port having the number 2 is set as “Ext.” in order to indicate that “Loc.” is an external port, and “type” is set as “AV” in order to indicate that the port having the number 2 is the port of the AV network. Referring back to FIG. 4, devices of the AV network that may access the AV network through the port having the number 2 are the PVR 420, the AVR 430, the STB 440, and the BDP 450. Thus, an AV network address RDA_PVR of the PVR 420, an AV network address RDA_AVR of the AVR 430, an AV network address RDA_STB of the STB 440, and an AV network address RDA_BDP of the BDP 450 are mapped to the port having the number 2. Since MAC addresses are also allocated to the PVR 420, the AVR 430, and the STB 440, a MAC address EMA_PVR of the PVR 420, a MAC address EMA_AVR of the AVR 430, and a MAC address EMA_STB of the STB 440 are also mapped to the port having the number 2.

Although not devices included in the AV network, the devices 460 and 470 of Ethernet type may also access Ethernet through the port having the number 2. Since the AV interface according to the present exemplary embodiment may also transmit Ethernet data, the TV 410 may also transmit the Ethernet data to the devices 460 and 470 of Ethernet type. However, since the TV 410 is not connected directly to Ethernet devices, the TV 410 transmits the Ethernet data through the AVR 430. Thus, the AV network address RDA_AVR of the AVR 430 connected to a router 460 and a PC 470 through an Ethernet port is mapped to the port having the number 2 together with a MAC address EMA_RTR of the router 460 and a MAC address EMA_PC of the PC 470. A device connected to the devices 460 and 470 of Ethernet type through the Ethernet port, such as the AVR 430, is defined as a portal device, and a portal AV network address corresponding to the MAC address EMA_RTR of the router 460 and the MAC address EMA_PC of the PC 470 is set as the AV network address RDA_AVR of the AVR 430.

FIG. 7B illustrates information about devices connected to ports of the PVR 420.

A port having the number 0 is an internal port, and the host 421 is connected to the port having the number 0. The port having the number 0 is set as “Int.” in order to indicate that “Loc.” indicating an external port or an internal port is an internal port, and an AV network address RDA_PVR and a MAC address EMA_PVR of the host 421 are mapped to the port having the number 0.

A port having the number 1 is an external port and is a port of the AV network. Thus, the port having the number 1 is set as “Ext.” in order to indicate that “Loc.” is an external port, and “type” is set as “AV” in order to indicate that the port having the number 1 is the port of the AV network. Since the TV 410 is connected to the port having the number 1, an AV network address RDA_TV and a MAC address EMA_TV of the TV 410 are mapped to the port having the number 1.

A port having the number 2 is an external port and is a port of the AV network. Thus, the port having the number 2 is set as “Ext.” in order to indicate that “Loc.” is an external port, and “type” is set as “AV” in order to indicate that the port having the number 2 is the port of the AV network. Devices of the AV network that the PVR 420 may access through the port having the number 2 are the AVR 430, the STB 440, and the BDP 450. Thus, the AV network address RDA_AVR of the AVR 430, the AV network address RDA_STB of the STB 440, and the AV network address RDA_BDP of the BDP 450 are mapped to the port having the number 2. Since MAC addresses are also allocated to the AVR 430 and the STB 440, the MAC address EMA_AVR of the AVR 430 and the MAC address EMA_STB of the STB 440 are also mapped to the port having the number 2.

The PVR 420 may also transmit the Ethernet data to the devices 460 and 470 of Ethernet type, like the TV 410. However, since the PVR 420 is not connected directly to Ethernet devices, the PVR 420 transmits the Ethernet data through the AVR 430. Thus, the AV network address RDA_AVR of the AVR 430 connected to the router 460 and the PC 470 through the Ethernet port is mapped to the port having the number 2 together with the MAC address EMA_RTR of the router 460 and the MAC address EMA_PC of the PC 470. A portal AV network address corresponding to the MAC address EMA_RTR of the router 460 and the MAC address EMA_PC of the PC 470 is set as the AV network address RDA_AVR of the AVR 430.

FIG. 7C illustrates information about devices connected to ports of the AVR 430.

A port having the number 0 is an internal port, and the host 431 is connected to the port having the number 0. The port having the number 0 is set as “Int.” in order to indicate that “Loc.” indicating an external port or an internal port is an internal port, and an AV network address RDA_AVR and a MAC address EMA_AVR of the host 431 are mapped to the port having the number 0.

A port having the number 1 is an external port and is a port of the AV network. Thus, the port having the number 1 is set as “Ext.” in order to indicate that “Loc.” is an external port, and “type” is set as “AV” in order to indicate that the port having the number 1 is the port of the AV network. Since the TV 410 and the PVR 420 may access the AV network through the port having the number 1, the AV network address RDA_TV and the MAC address EMA_TV of the TV 410 and the AV network address RDA_PVR and the MAC address EMA_PVR of the PVR 420 are mapped to the port having the number 1.

A port having the number 2 is an external port and is a port of the AV network. Thus, the port having the number 2 is set as “Ext.” in order to indicate that “Loc.” is an external port, and “type” is set as “AV” in order to indicate that the port having the number 2 is the port of the AV network. A device of the AV network that the AVR 430 may access through the port having the number 2 is the STB 440. The AV network address RDA_STB and the MAC address EMA_STB of the STB 440 are mapped to the port having the number 2.

A port having the number 3 is an external port and is a port of the AV network. Thus, the port having the number 3 is set as “Ext.” in order to indicate that “Loc.” is an external port, and “type” is set as “AV” in order to indicate that the port having the number 3 is the port of the AV network. A device of the AV network that the AVR 430 may access through the port having the number 3 is the BDP 450. The AV network address RDA_BDP of the BDP 450 is mapped to the port having the number 3.

A port having the number 4 is an external port and is an Ethernet port. Thus, the port having the number 4 is set as “Ext.” in order to indicate that “Loc.” is an external port, and “type” is set as “Eth” in order to indicate that the port having the number 4 is the Ethernet port. Devices that the AVR 430 may access through the port having the number 4 are the router 460 and the PC 470. Thus, the MAC address EMA_RTR of the router 460 and the MAC address EMA_PC of the PC 470 are mapped to the port having the number 4. Since the AVR 430 itself is a portal device, a portal AV network address corresponding to the MAC address EMA_RTR of the router 460 and the MAC address EMA_PC of the PC 470 is set as the AV network address RDA_AVR of the AVR 430.

FIG. 7D illustrates information about devices connected to ports of the STB 440.

A port having the number 0 is an internal port, and the host 441 is connected to the port having the number 0. The port having the number 0 is set as “Int.” in order to indicate that “Loc.” indicating an external port or an internal port is an internal port, and an AV network address RDA_STB and a MAC address EMA_STB of the host 441 are mapped to the port having the number 0.

A port having the number 1 is an external port and is a port of the AV network. Thus, the port having the number 1 is set as “Ext.” in order to indicate that “Loc.” is an external port, and “type” is set as “AV” in order to indicate that the port having the number 1 is the port of the AV network. Since the TV 410, the PVR 420 and the AVR 430 may access the AV network through the port having the number 1, the AV network address RDA_TV and the MAC address EMA_TV of the TV 410, the AV network address RDA_PVR and the MAC address EMA_PVR of the PVR 420, and the AV network address RDA_AVR and the MAC address EMA_AVR of the AVR 430 are mapped to the port having the number 1.

The STB 440 may also transmit the Ethernet data to the devices 460 and 470 of Ethernet type. However, since the STB 440 is not connected directly to Ethernet devices, the STB 440 transmits the Ethernet data through the AVR 430. Thus, the AV network address RDA_AVR of the AVR 430 connected to the router 460 and the PC 470 through the Ethernet port is mapped to the port having the number 1 together with the MAC address EMA_RTR of the router 460 and the MAC address EMA_PC of the PC 470. A portal AV network address corresponding to the MAC address EMA_RTR of the router 460 and the MAC address EMA_PC of the PC 470 is set as the AV network address RDA_AVR of the AVR 430.

FIG. 7E illustrates information about devices connected to ports of the BDP 450.

A port having the number 0 is an internal port, and the host 451 is connected to the port having the number 0. The port having the number 0 is set as “Int.” in order to indicate that “Loc.” indicating an external port or an internal port is an internal port, and an AV network address RDA_BDP and a MAC address EMA BDP of the host 451 are mapped to the port having the number 0.

A port having the number 1 is an external port and is a port of the AV network. Thus, the port having the number 1 is set as “Ext.” in order to indicate that “Loc.” is an external port, and “type” is set as “AV” in order to indicate that the port having the number 1 is the port of the AV network. Since the TV 410, the PVR 420, the AVR 430 and the STB 440 may access the AV network through the port having the number 1, the AV network address RDA_TV of the TV 410, the AV network address RDA_PVR of the PVR 420, the AV network address RDA_AVR of the AVR 430, and the AV network address RDA_STB of the STB 440 are mapped to the port having the number 1. Since Ethernet addresses are not allocated to the BDP 450, the BDP 450 may not transmit or receive the Ethernet data. Thus, MAC addresses do not need to be mapped to the port having the number 1.

FIG. 7F illustrates information about devices connected to ports of the router 460.

A port having the number 0 is an internal port, and the host 461 is connected to the port having the number 0. The port having the number 0 is set as “Int.” in order to indicate that “Loc.” indicating an external port or an internal port is an internal port, and a MAC address EMA_RTR of the host 461 is mapped to the port having the number 0.

A port having the number 2 is an external port and is an Ethernet port. Thus, the port having the number 2 is set as “Ext.” in order to indicate that “Loc.” is an external port. Since the TV 410, the PVR 420, the AVR 430, and the STB 440 may access Ethernet through the port having the number 2, the MAC address EMA_TV of the TV 410, the MAC address EMA_PVR of the PVR 420, the MAC address EMA_AVR of the AVR 430, and the MAC address EMA_STB of the STB 440 are mapped to the port having the number 2.

A port having the number 3 is an external port and is an Ethernet port. Thus, the port having the number 3 is set as “Ext.” in order to indicate that “Loc.” is an external port. Since the PC 470 may access Ethernet through the port having the number 3, the MAC address EMA_PC of the PC 470 is mapped to the port having the number 3.

FIG. 7G illustrates information about devices connected to ports of the PC 470.

A port having the number 0 is an internal port, and the host 471 is connected to the port having the number 0. The port having the number 0 is set as “Int.” in order to indicate that “Loc.” indicating an external port or an internal port is an internal port, and a MAC address EMA_PC of the host 471 is mapped to the port having the number 0.

A port having the number 1 is an external port and is an Ethernet port. Thus, the port having the number 1 is set as “Ext.” in order to indicate that “Loc.” is an external port. Since the TV 410, the PVR 420, the AVR 430, the STB 440, and the router 460 may access Ethernet through the port having the number 1, the MAC address EMA_TV of the TV 410, the MAC address EMA_PVR of the PVR 420, the MAC address EMA_AVR of the AVR 430, the MAC address EMA_STB of the STB 440, and the MAC address EMA_RTR of the router 460 are mapped to the port having the number 1.

In the tables illustrated in FIGS. 7A through 7D, MAC addresses of Ethernet devices and AV network addresses of portal devices are mapped to the same port. For example, the MAC address EMA_RTR of the router 460 and the MAC address EMA_PC of the PC 470 are mapped to the same port together with a portal device, i.e., the AV network address RDA_AVR of the AVR 430. Each of a port mapping of AV network addresses and a port mapping of MAC addresses may be performed using the same method of a method of generating a routing table according to the related art. However, the following method may be used to correspond MAC addresses of the Ethernet devices and AV network addresses of portal devices to one another.

When the TV 410 generates the table of FIG. 7A, the TV 410 transmits a request message for requesting information about a device of the AV network connected to the PC 470 through an Ethernet port to devices 420, 430, 440, and 450 of the AV network. The transmitted request message is a message according to a protocol of the AV network and may be a message to be broadcasted to all devices connected through AV links. The request message including information about the MAC address EMA_PC of the PC 470 is broadcasted to the devices 420, 430, 440, and 450.

The devices 420, 430, 440, and 450 of the AV network that receive the broadcasted message transmit to the TV 410 a response message indicating that the AVR 430 is a device of the AV network connected to the PC 470. A unicast method may be used herein. The AVR 430 itself, which is a portal device, may transmit the response message to the TV 410, and another device recognizing that the AVR 430 is a portal device, may also transmit a response message indicating that the AVR 430 is a portal device to the TV 410.

When the AVR 430 itself transmits the response message to the TV 410, a source AV network address of the response message is set as the AV network address RDA_AVR of the AVR 430 and is transmitted to the TV 410 so that the response message indicating that the AVR 430 is a portal device can be informed to the TV 410.

In addition, in the tables illustrated in FIGS. 7A through 7D, AV network addresses of devices of the AV network are mapped to a port together with MAC addresses of the devices of the AV network. Referring to FIG. 7C, the AV network address RDA_TV of the TV 410 and the MAC address EMA_TV of the TV 410 are together mapped to the port having the number 1. As described above, each of a port mapping of AV network addresses and a port mapping of MAC addresses may be performed based on the method of generating a routing table according to the related art. However, the following method may be used to correspond the AV network addresses and MAC addresses of devices of the AV network to one another and to map them to one port.

When the AVR 430 generates the table of FIG. 7C, in order to correspond the AV network address RDA_TV of the TV 410 and the MAC address EMA_TV of the TV 410 to one another and to map them to one port, the AVR 430 broadcasts a request message for requesting an AV network address corresponding to the MAC address EMA_TV of the TV 410 to the devices 410, 420, 430, and 450 of the AV network. Even when the AVR 430 recognizes each of the MAC address EMA_TV of the TV 410 and the AV network address RDA_TV of the TV 410 by using the method of generating the routing table according to the related art, whether the MAC address EMA_TV of the TV 410 corresponds to the AV network address RDA_TV of the TV 410 cannot be recognized. Thus, the request message including information about the MAC address EMA_TV of the TV 410 is broadcasted to the devices 410, 420, 430, and 450 of the AV network.

The devices 410, 420, 430, and 450 of the AV network that receive the broadcasted request message transmit to the AVR 430 a response message indicating that the AV network address RDA_TV of the TV 410 corresponds to the MAC address EMA_TV of the TV 410. A unicast method may be used herein. The TV 410 itself may also transmit the response message to the AVR 430, and another device recognizing that the MAC address EMA_TV of the TV 410 corresponds to the AV network address EMA_RDA of the TV 410 may also transmit the response message to the AVR 430. When the TV 410 itself transmits the response message to the AVR 430, a source AV network address of the response message may be set as the AV network address RDA_TV of the TV 410.

The devices of the AV network broadcast their AV network addresses and MAC addresses periodically without exchanging the above-described request message and response message, thereby generating the tables of FIGS. 7A through 7D. Since the AV network addresses and the MAC addresses corresponding to the AV network addresses of the devices of the AV network are periodically broadcasted, an additional message exchange for corresponding the AV network addresses and the MAC addresses of the devices of the AV network to one another is not needed. A portal device, such as the AVR 430, may periodically broadcast the MAC addresses EMA_RTR and EMA_PC of the devices 460 and 470 of Ethernet type connected to one another through the Ethernet port, as well as the AV network address RDA_AVR and the MAC address EMA_AVR of the AVR 430.

In addition, according to another exemplary embodiment, devices of the AV network may not broadcast their AV network addresses and MAC addresses, but one coordinator from among the devices of the AV network may be determined, and the determined coordinator may periodically broadcast information relating to the AV network addresses and MAC addresses of the devices of the AV network.

Referring back to FIG. 4, the devices 410, 420, 430, 440, and 450 of the AV network and the devices 460 and 470 of Ethernet type transmit or receive data based on the tables illustrated in FIGS. 7A through 7G.

A case where a predetermined device of the AV network transmits Ethernet data to a predetermined device of Ethernet type will now be described. For example, a case where the TV 410 of the AV network transmits the Ethernet data to the PC 470 of Ethernet type will now be described.

The host 411 of the TV 410 generates a transmission unit of Ethernet type to be transmitted to the PC 470, i.e., an Ethernet frame. The source MAC address of the Ethernet frame is set as the MAC address EMA_TV of the TV 410, and the destination MAC address of the Ethernet frame is set as the MAC address EMA_PC of the PC 470.

The generated Ethernet data is transmitted to a switch 416. The switch 416 determines a port of the AV network to which the MAC address EMA_PC of the PC 470 is mapped, by referring to the table of FIG. 7A. A port 413 having the number 2 is determined as the port of the AV network to which the MAC address EMA_PC of the PC 470 is mapped, and the Ethernet data is transmitted to the port 413 having the number 2. The port 413 having the number 2 generates a transmission unit of the AV network including the Ethernet data received from the switch 416. Here, packets described above with reference to FIG. 6 may be generated. The source AV network address of the transmission unit of the AV network is set as the AV network address RDA_TV of the TV 410, and the destination AV network address thereof is set as the AV network address RDA_AVR of the AVR 430.

A port 430 having the number 2 may set an AV network address of a portal device corresponding to the MAC address EMA_PC of the PC 470, i.e., the AV network address RDA_AVR of the AVR 430, as the destination AV network address by referring to the table of FIG. 7A.

The generated transmission unit of the AV network is transmitted to a port 422 having the number 1 of the PVR 420 through AV link. The port 422 having the number 1 of the PVR 420 transmits the received transmission unit of the AV network to a switch 426, and the switch 426 determines a port to transmit the transmission unit of the AV network by referring to the destination AV network address of the transmission unit of the AV network. Since the destination AV network address is set as the AV network address RDA_AVR of the AVR 430, the transmission unit of the AV network is transmitted to a port 423 having the number 2 by referring to the table of FIG. 7B.

The port 423 having the number 2 transmits the transmission unit of the AV network to a port 432 having the number 1, and the port 432 having the number 1 of the AVR 430 transmits the received transmission unit of the AV network to a switch 436. The switch 436 determines a port to transmit the Ethernet data by referring to the destination AV network address of the transmission unit of the AV network and the destination MAC address of the Ethernet data included in the transmission unit of the AV network. Since the destination AV network address of the transmission unit of the AV network is set as the AV network address RDA_AVR of the AVR 430, the transmission unit of the AV network is not transmitted to a port of another AV network. Thus, the Ethernet data included in a portion “Data” of the transmission unit of the AV network is depacketized, and the destination MAC address of the Ethernet data is determined.

Referring to FIG. 7C, since the destination MAC address is set as the MAC address EMA_PC of the PC 470 and a port to which the MAC address EMA_PC of the PC 470 is mapped is a port 435 having the number 4, the Ethernet data is transmitted to the port 435 having the number 4 that is an Ethernet port. The port 435 having the number 4 transmits the Ethernet data to a port 462 having the number 2 of the router 460 through Ethernet link, and the switch 416 of the router 460 compares the destination MAC address of the Ethernet data with the table of FIG. 7F and determines a port 463 having the number 3 as a port to transmit the Ethernet data. The Ethernet data is transmitted to a port 472 having the number 1 of the PC 470 through the port 463 having the number 3, and the port 472 having the number 1 of the PC 470 transmits the received Ethernet data to the host 471.

Furthermore, even when a predetermined device of Ethernet type transmits the Ethernet data to a predetermined device of the AV network, the Ethernet data is transmitted or received based on the tables of FIGS. 7A through 7G. For example, a case where the PC 470 of Ethernet type transmits the Ethernet data to the TV 410 of the AV network will now be described.

The host 471 of the PC 470 generates a transmission unit of Ethernet type, i.e., an Ethernet frame. The source MAC address of the Ethernet frame is set as the MAC address EMA_PC of the PC 470, and the destination MAC address of the Ethernet frame is set as the MAC address EMA_TV of the TV 410.

The generated Ethernet data is transmitted to the Ethernet port 472 based on the routing table of FIG. 7G. The Ethernet port 472 transmits the Ethernet data to the port 463 having the number 3 of the router 460 through Ethernet link, and the port 463 having the number 3 of the router 460 transmits the Ethernet data to a switch 466. The switch 466 determines a port to which the destination MAC address, i.e., the MAC address EMA_TV of the TV 410 is mapped, by referring to the routing table of FIG. 7F and transmits the Ethernet data to the port 462 having the number 2 according to the result of determination.

The port 462 having the number 2 transmits the Ethernet data to the port 435 having the number 4 of the AVR 430 through AV link, and the port 435 having the number 4 transmits the received Ethernet data to a switch 436. The switch 436 determines a port to which the MAC address EMA_TV of the TV 410, which is the destination MAC address, is mapped, by referring to the table of FIG. 7C. As a result of referring to the table of FIG. 7C, the port to which the MAC address EMA_TV of the TV 410 is mapped, is determined as a port 432 having the number 1 that is a port of the AV network.

When the switch 436 transmits the Ethernet frame to the port 432 having the number 1, the port 432 having the number 1 generates a transmission unit of the AV network including the Ethernet data. Since the Ethernet data is transmitted from the AVR 430 to the TV 410 through link of the AV network, the transmission unit of the AV network including the Ethernet data is generated in a portion “data”, as illustrated in FIG. 6, and the generated transmission unit of the AV network is transmitted to the port 423 having the number 2 of the PVR 420 through a link of the AV network.

The destination AV network address of the transmission unit of the AV network is set as the AV network address RDA_TV of the TV 410, and the source AV network address of the transmission unit of the AV network is set as the AV network address RDA_AVR of the AVR 430.

The port 423 having the number 2 of the PVR 420 transmits to the switch 426 the received transmission unit of the AV network, and the switch 426 determines the destination AV network address, i.e., the AV network address RDA_TV of the TV 410 by referring to the table of FIG. 7B. When the port 422 having the number 1 is determined as a port corresponding to the destination AV network address based on the table of FIG. 7B, a switch 426 transmits the received transmission unit of the AV network to the port 422 having the number 1, and the port 422 having the number 1 transmits the received transmission unit of the AV network to a port 413 having the number 2 of the TV 410 through AV link.

The port 413 having the number 2 transmits the received transmission unit of the AV network to a switch 416, and the switch 416 determines whether the destination AV network address and the MAC address of the received transmission unit of the AV network coincide with the AV network address RDA_TV of the TV 410 and the MAC address EMA_TV of the TV 410. If it is determined that the destination AV network address and the MAC address of the received transmission unit of the AV network coincide with the AV network address RDA_TV of the TV 410 and the MAC address EMA_TV of the TV 410, the switch 416 transmits the Ethernet data to the host 411.

In addition, according to another exemplary embodiment, the Ethernet data may be transmitted without using the tables of FIGS. 7A through 7D. As described above, each of a port mapping of an AV network address and a port mapping of a MAC address may be performed by using the method of generating the routing table according to the related art. In other words, the devices of the AV network recognize that the AV network address and the MAC address of devices are connected to one another through a port of each of the devices of the AV network. When each of a port mapping of the AV network address and a port mapping of the MAC address is performed according to the related art, correspondence between the AV network address and the MAC address cannot be recognized.

Thus, the devices of the AV network transmit the Ethernet data to neighbor devices so that the Ethernet data may be transmitted to a device corresponding to the destination MAC address. A case where the TV 410 transmits the Ethernet data to the PC 470 will now be described with reference to FIG. 4.

The TV 410 recognizes that the TV 410 is connected to the PC 470 through the port 413 having the number 2 by using the method of generating the routing table according to the related art. However, since the correspondence between the AV network address and the MAC address cannot be recognized, the Ethernet data is transmitted to the PVR 420 connected directly to the port 413 having the number 2. The destination MAC address of the Ethernet data is set as the MAC address EMA_PC of the PC 470. By setting the AV network address of the PVR 420 as the destination AV network address, the transmission unit of the AV network including the Ethernet data may be generated, and the generated transmission unit may be transmitted. Since the transmission unit of the AV network is transmitted to the device connected directly to the port 413 having the number 2, the destination AV network address may not be set, or a default AV network address RDA Neighbor indicating an AV network address of an unspecified, neighbor device of the AV network may also be set as the destination AV network address.

The PVR 420 depacketizes the received transmission unit of the AV network, checks the destination MAC address of the Ethernet data and determines a port to which the destination MAC address is mapped. Since the destination MAC address is set as the MAC address EMA_PC of the PC 470, the Ethernet data is transmitted to the AVR 430 through the port 423 having the number 2 to which the MAC address EMA_PC of the PC 470 is mapped. The transmission unit of the AV network including the Ethernet data is generated without changing the source MAC address and destination MAC address of the Ethernet data and is transmitted to the AVR 430. The transmission unit of the AV network including the Ethernet data is generated by setting the AV network address of the AVR 430 as the destination AV network address, and the generated transmission unit may be transmitted. Since the transmission unit of the AV network is transmitted to the device connected directly to the port 423 having the number 2, the destination AV network address may not be set, or a default AV network address RDA Neighbor indicating an AV network address of a unspecified, neighbor device of the AV network may also be set as the destination AV network address.

The AVR 430 depacketizes the received transmission unit of the AV network, checks the destination MAC address of the Ethernet data and determines a port to which the destination MAC address is mapped. The port 435 having the number 4 that is an Ethernet port is determined as the port to which the destination MAC address is mapped, and the AVR 430 transmits the Ethernet data to the router 460 through the port 435 having the number 4. The router 460 transmits the received Ethernet data to the PC 470 by referring to the table of FIG. 7F.

FIG. 8 is a block diagram of an apparatus 800 for transmitting data, according to an exemplary embodiment.

The apparatus 800 for transmitting data illustrated in FIG. 8 may be an apparatus included in a first device of a first type network for transmitting data to a second device of a second type network or an apparatus included in the second device of the second type network for transmitting data to the first device of the first type network. Hereinafter, a case where the first type network is an AV network and the second type network is an Ethernet network will be described. Thus, an AV network address is an address of the first type network, and a MAC address is an address of the second type network. In addition, a port of the AV network is a port of the first type network, and the Ethernet port is a port of the second type network.

However, the AV network and Ethernet network are examples, and one of ordinary skill in the art would understand that two types of networks having different network protocols may be the first type network and the second type network.

Referring to FIG. 8, the apparatus 800 for transmitting data includes a host unit 810 and a port unit 820.

A case where the apparatus 800 for transmitting data is an apparatus of a first device of the AV network for transmitting data to a second device of an Ethernet network will now be described. Hereinafter, the first device may be the TV 410, the second device may be the PC 470, and the third device may be the AVR 430.

The host unit 810 generates a transmission unit of Ethernet type, e.g., an Ethernet frame, by setting a MAC address of the second device as a destination address. Since an AV interface according to an exemplary embodiment also supports transmitting and receiving of Ethernet data, the MAC address is allocated to the host unit 810 of the first device that is a device of the AV network, and a transmission unit of Ethernet type may be transmitted or received to or from the second device. The host unit 810 generates the transmission unit of Ethernet type by setting the MAC address of the first device as a source MAC address and by setting the MAC address of the second device as a destination MAC address. The transmission unit of Ethernet type may be generated by deleting additional information, such as at least one of a preamble, a starting frame delimiter (SFD), a frame check sequence (FCS), etc.

The port unit 820 generates a transmission unit of the AV network by setting an AV network address corresponding to the MAC address of the second device as a destination address. The port unit 820 may be a port of the AV network. The AV network address of the first device is set as a source address of the transmission unit of the AV network. The transmission unit of the AV network includes the Ethernet data generated by the host unit 810 as described above with reference to FIG. 6. The transmission unit of the AV network may be generated by referring to the table described above with reference to FIGS. 7A through 7D.

In other words, the AV network address corresponding to the MAC address of the second device is determined using the tables of FIGS. 7A through 7D, indicating correspondence between the AV network addresses and the MAC addresses. Since the second device is a device of an Ethernet network and the AV network address is not allocated to the second device, the determined AV network address may be an AV network address of a third device of the AV network connected to the second device through the Ethernet port.

The first device that is not connected directly to the second device through the Ethernet port sets an AV network address of the third device that is a device of the AV network as a destination address and generates and transmits a transmission unit of the AV network including the Ethernet data. The third device transmits the Ethernet data included in the received transmission unit of the AV network to the first device through the Ethernet port connected to the first device. When the first device generates the Ethernet data and deletes the additional information from the Ethernet frame, the first device adds the additional information to the Ethernet frame and transmits the additional information to the third device.

The transmission unit of the AV network may also be transmitted to a device that is directly in the neighborhood with the first device without setting the AV network address of the third device as a destination address. In this regard, the destination AV network address may be an AV network address of the device that is directly in the neighborhood with the first device or a default AV network address indicating a device that is in the neighborhood with the first device. The neighbor device determines an AV network port to which the destination MAC address is mapped, by referring to a destination MAC address of the Ethernet data, and transmits a transmission unit of the AV network including the Ethernet data to another neighbor device through the determined port. When the transmission unit of the AV network is continuously transmitted to neighbor devices, the transmission unit of the AV network including the Ethernet data is finally transmitted to a third device.

A case where the apparatus 800 for transmitting data is a second device of Ethernet type for transmitting data to a first device of the AV network will now be described.

The host unit 810 generates a transmission unit of Ethernet type, e.g., an Ethernet frame, by setting a MAC address of the first device as a destination address. The port unit 820 transmits the generated Ethernet transmission unit to a device of the AV network corresponding to the MAC address of the first device, i.e., the third device. The port unit 820 may be an Ethernet port. The Ethernet data is transmitted to the third device by referring to the table of FIG. 7G.

Although the MAC address is allocated to the first device and the first device is not connected directly to the second device through the Ethernet port, the port unit 820 transmits Ethernet data to the third device that is connected directly to the second device through the Ethernet port.

The third device determines a port of the AV network to which the MAC address of the first device is mapped, by referring to the table of FIG. 7C. When the port of the AV network is determined by the third device, the third device generates a transmission unit of the AV network of a first network by setting an AV network address of the first device as a destination AV network address. The generated transmission unit of the AV network includes the Ethernet data received from the second device. The generated transmission unit of the AV network is transmitted to the first device through the port of the AV network determined by referring to FIG. 7C.

As described above, the transmission unit of the AV network may also be transmitted to a neighbor device through the port of the AV network corresponding to the destination MAC address of the Ethernet data without setting the AV network address of the first device as the destination AV network address.

In FIG. 8, a unit that performs switching has been omitted. However, when a device including the apparatus 800 for transmitting data illustrated in FIG. 8 is a device including a plurality of AV network ports and Ethernet ports and performing switching in the AV network, the device may include the unit that performs switching by referring to the AV network addresses and the MAC addresses. A method of operating the unit that performs switching has been described above with reference to the switches illustrated in FIGS. 4 and 5.

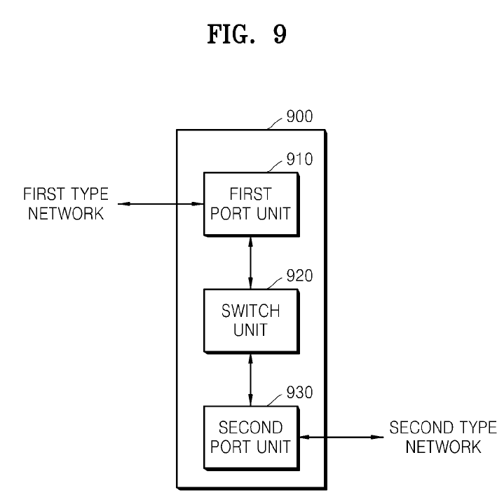

FIG. 9 is a block diagram of an apparatus 900 for relaying data, according to an exemplary embodiment.

FIG. 9 illustrates an apparatus for relaying Ethernet data, the apparatus being included in a third device and the Ethernet data to be transmitted by a first device of the AV network to a second device of an Ethernet network or an apparatus for relaying Ethernet data to be transmitted by the second device of the Ethernet network to the first device of the AV network. The apparatus 900 for relaying data of FIG. 9 may be an apparatus for relaying data included in the AVR 430 of FIG. 4.

Referring to FIG. 9, the apparatus 900 for relaying data includes a first port unit 910, a switch unit 920, and a second port unit 930.

A case where the apparatus 900 for relaying data relays data transmitted by the first device of the AV network to the second device of the Ethernet network will now be described.

The first port unit 910 receives a transmission unit of the AV network including the Ethernet data from the first device. The first port unit 910 may be a port of the AV network. An AV network address of the third device is set as a destination AV network address of the AV network, and a MAC address of the second device is set as a destination MAC address. The first device sets the AV network address corresponding to the MAC address of the second device as a destination AV network address of the transmission unit of the AV network by referring to the table of FIG. 7A. Since the AV network address of the third device correspond to the MAC address of the second device, the transmission unit of the AV network including the Ethernet data is transmitted to the third device. The first port unit 910 receives the transmission unit of the AV network transmitted by the first device.

The received transmission unit of the AV network may be a transmission unit of the AV network transmitted to the third device by transmitting the transmission unit of the AV network to a neighbor device through the port of the AV network to which a destination MAC address of the Ethernet data is mapped, without setting the AV network address of the third device as a destination AV network address.

The switch unit 920 determines an Ethernet port corresponding to the MAC address of the second device by referring to the table of FIG. 7C. The destination AV network address of the transmission unit of the AV network received through a first port is set as an AV network address of the third device. Thus, there is no port for transmitting the transmission unit of the AV network through the AV network.

The switch unit 920 determines an Ethernet port to which a MAC address of the second device is mapped, by referring to the destination MAC address of the Ethernet data included in the transmission unit of the AV network, i.e., the MAC address of the second device.

The second port unit 930 transmits the Ethernet data received by the switch unit 920 to the second device. The second port unit 930 may be an Ethernet port corresponding to the MAC address of the second device. When the Ethernet frame received from the first device is an Ethernet frame from which additional information, such as a preamble, an SFD, or an FCS, is deleted, the additional information added to the Ethernet frame may be transmitted to the second device.

A case where the apparatus 900 relays data transmitted by the second device of the Ethernet network to the first device of the AV network will now be described.

The second port unit 930 receives Ethernet data from the second device. The second port unit 930 may be an Ethernet port. The second port unit 930 may receive the Ethernet frame according to an Ethernet protocol.

The switch unit 920 determines a port of the AV network to which a destination MAC address is mapped, by referring to the destination MAC address of the Ethernet data received by the second port unit 930 and the table of FIG. 7C.

The first port unit 910 transmits to the first device the Ethernet data received from the switch unit 920. The first port unit 910 may be a port to which the AV network address corresponding to the destination MAC address determined by the switch unit 920, i.e., the AV network address of the first device, is mapped. A transmission unit of the AV network including the Ethernet data received from the switch unit 920 is generated, and the generated transmission unit of the AV network is transmitted to the first device. The destination AV network address of the AV network may be an AV network address of the first device. Additional information included in the Ethernet frame received by the second port unit 930 may be deleted, and the transmission unit of the AV network, including the Ethernet data from which the additional information are deleted, may be generated.

The transmission unit of the AV network may also be continuously transmitted to a neighbor device through the port of the AV network to which the destination MAC address of the Ethernet data is mapped, without setting the AV network address of the first device as destination AV network address.

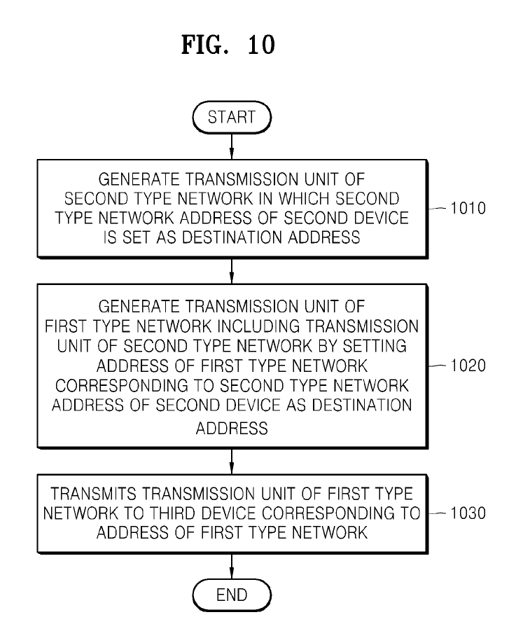

FIG. 10 is a flowchart illustrating a method of transmitting data, according to an exemplary embodiment.

FIG. 10 illustrates a method of transmitting data to a second device of an Ethernet network by using a first device of the AV network.

Referring to FIG. 10, in operation 1010, an apparatus for transmitting data of a first device generates a transmission unit of a second type network in which a second type network address of the second device is set as a destination address. For example, Ethernet data in which a MAC address of the second device is set as a destination MAC address may be generated. A source MAC address is set as a MAC address of the first device.

In operation 1020, the apparatus for transmitting data generates a transmission unit of a first type network, including the transmission unit of the second type network, by setting a first type network address corresponding to the second type network address of the second device as a destination address.

For example, an AV network address corresponding to the MAC address of the second device is determined by referring to the tables of FIGS. 7A through 7D, and a transmission unit of the AV network is generated by setting the determined AV network address as a destination AV network address. The destination AV network address determined by referring to the tables of FIGS. 7A through 7D may be an AV network address of a third device of the AV network connected to the second device through an Ethernet port. A source AV network address may be set as the AV network address of the first device. The transmission unit of the AV network may include Ethernet data, i.e., a transmission unit of an Ethernet network.

In operation 1030, the apparatus for transmitting data transmits to the third device the transmission unit of the first type network generated in operation 1010. Since the first device is not connected directly to the second device, the first device transmits the transmission unit of the AV network to the third device. The third device determines an Ethernet port to which the destination MAC address of the Ethernet data included in the transmission unit of the AV network is mapped and transmits the transmission unit of the AV network to the second device through the determined Ethernet port.

The transmission unit of the AV network is transmitted to the neighbor device through the port of the AV network to which the destination MAC address of the Ethernet data is mapped, without setting the AV network address of the third device as the destination AV network address so that the transmission unit of the AV network may also be transmitted to the third device.

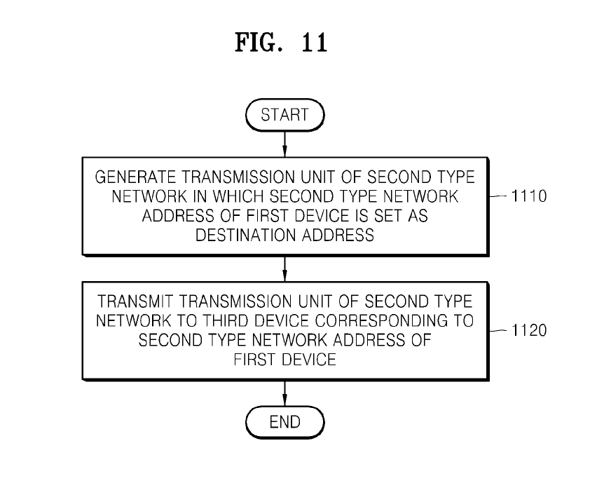

FIG. 11 is a flowchart illustrating a method of transmitting data, according to another exemplary embodiment.

FIG. 11 illustrates a method of transmitting data to the first device of the AV network by using the second device of an Ethernet network.

Referring to FIG. 11, in operation 1110, an apparatus for transmitting data of the second device generates a transmission unit of a second type network in which a second type network address of the first device is set as a destination address. For example, Ethernet data, in which a MAC address of the first device is set as a destination MAC address, is generated. A source MAC address is set as a MAC address of the second device.

In operation 1120, the second device transmits the transmission unit of the second type network generated in operation 1110 to the third device corresponding to the second type network address of the first device. The third device is connected to the first device through a port of the AV network. Since the second device is not connected directly to the first device through the Ethernet port, the Ethernet data is transmitted to the third device. The third device determines a port of the AV network to which a destination MAC address is mapped, by referring to the destination MAC address of the Ethernet data, generates a transmission unit of the AV network including the Ethernet data and transmits the generated transmission unit of the AV network to the first device. The destination AV network address of the AV network is set as an AV network address corresponding to the MAC address of the first device.

The transmission unit of the AV network may also be continuously transmitted to a neighbor device through the port of the AV network to which the destination MAC address of the Ethernet data is mapped, without setting the AV network address of the first device as a destination AV network address.

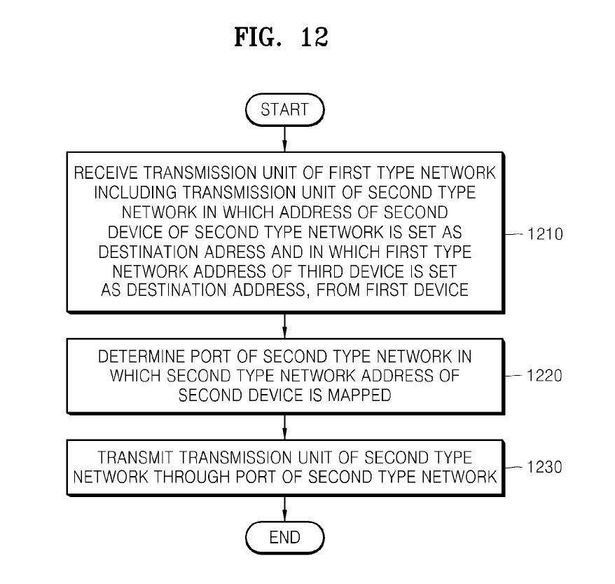

FIG. 12 is a flowchart illustrating a method of relaying, according to an exemplary embodiment.

FIG. 12 illustrates a method of relaying data transmitted by the first device of the AV network to the second device of the Ethernet network by using the third device connected to the second device through an Ethernet port.

Referring to FIG. 12, in operation 1210, an apparatus for relaying data receives a transmission unit of a first type network in which a first type network address of the third device is set as a destination address, from the first device. The transmission unit of the first type network includes a transmission unit of a second type network transmitted by the first device to the second device.

Since the first device is not connected directly to the second device through the Ethernet port, the transmission unit of the AV network, including the Ethernet data, is transmitted to the third device connected directly to the second device through the Ethernet port. A source MAC address of the Ethernet data is set as a MAC address of the first device, and a destination MAC address of the Ethernet data is set as a MAC address of the second device. The transmission unit of the AV network includes a source AV network address set as an AV network address of the first device and a destination AV network address set as an AV network address of the third device.

In operation 1220, the apparatus for relaying data determines a port of the second type network in which a second type network address of the second device is mapped. The transmission unit of the AV network received in operation 1210 includes an AV network address of the third device set as a destination AV network address. Thus, since there is no device for transmitting the transmission unit of the AV network, the apparatus for relaying data determines an Ethernet port to which a destination MAC address is mapped, by referring to the destination MAC address of the Ethernet data included in the transmission unit of the AV network.

In operation 1230, the apparatus for relaying data transmits the transmission unit of the second type network through the port of the second type network that is determined in operation 1220. The apparatus transmits the Ethernet data through the Ethernet port determined in operation 1220.

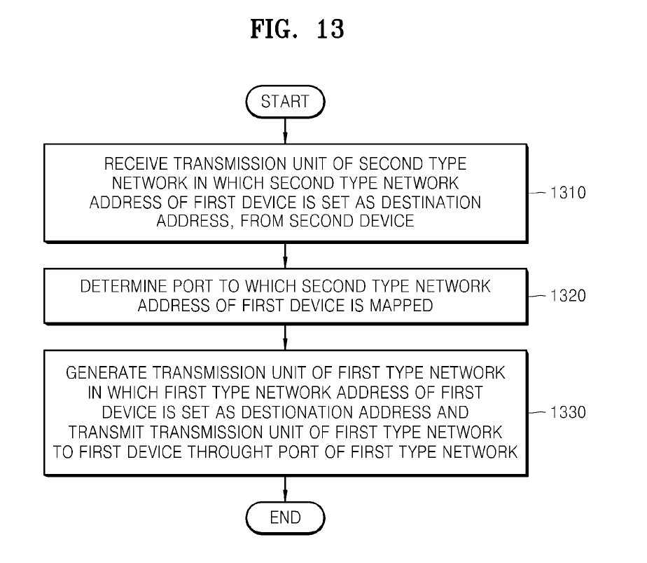

FIG. 13 is a flowchart illustrating a method of relaying data, according to another exemplary embodiment.

FIG. 13 illustrates a method of relaying data transmitted by the second device of the Ethernet network to the first device of the AV network by using the third device connected to the second device through an Ethernet port.

In operation 1310, an apparatus for relaying data receives a transmission unit of a second type network in which a second type network address of the first device is set as a destination address, from the second device. Ethernet data, in which a MAC address of the first device is set as a destination MAC address, is received from the second device through the Ethernet port.

In operation 1320, the apparatus for relaying data determines a port to which the second type network address of the first device is mapped. The port to which the MAC address of the first device set as the destination MAC address of the Ethernet data received in operation 1310 is mapped is determined. Since the third device and the first device are connected to each other through a port of the AV network, the port of the AV network connected to the first device is determined.

In operation 1330, the apparatus for relaying data generates the transmission unit of the first type network, including the transmission unit of the second type network received in operation 1310, and transmits the generated transmission unit of the first type network to the first device through the port of the first type network.

The transmission unit of the AV network, including the Ethernet data received in operation 1310, is generated. A destination AV network address of the transmission unit of the AV network is set as an AV network address of the first device and the transmission unit of the AV network is transmitted to the first device through the port of the AV network that is determined in operation 1320.

According to one or more exemplary embodiments, a device of a network based on an AV interface can transmit Ethernet data to a device outside of the network. Thus, the Ethernet data, as well as AV data, can be transmitted through the network based on the AV interface so that the utility of AV devices can be maximized. Furthermore, a device that is not connected via the AV interface can access a device of the network based on the AV interface freely so that various types of services can be provided.

While exemplary embodiments have been particularly shown and described above, it will be understood by those of ordinary skill in the art that various changes in form and details may be made therein without departing from the spirit and scope of the present inventive concept as defined by the following claims. In addition, a system according to an exemplary embodiment can be implemented using a computer-readable code in a computer-readable recording medium.

For example, an apparatus for transmitting data and an apparatus for relaying data according to exemplary embodiments can include a bus coupled to units of each of the devices shown in FIGS. 8 and 9 and at least one processor connected to the bus. In addition, a memory coupled to at least one processor for performing commands as described above can be included and connected to the bus to store the commands and received messages or generated messages.

The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks and, optical data storage devices. The computer-readable recording medium can also be distributed over network-coupled computer systems so that the computer-readable code is stored and executed in a distributed fashion.

What is claimed is:

1. A method of transmitting data to a second device by using a first device, the method comprising:
generating a transmission unit of a second type network in which a second type network address of the second device is set as a destination address;
generating a transmission unit of a first type network comprising the generated transmission unit of the second type network by setting a first type network address of a third device, corresponding to the second type network address of the second device, as a destination address; and
transmitting the generated transmission unit of the first type network to the third device.

2. The method of claim 1, wherein the third device transmits the transmission unit of the second type network to the second device corresponding to the second type network address.

3. The method of claim 2, wherein the first type network comprises an audio/video (AV) network connected via a link that is capable of performing bidirectional transmission of AV data, and the second type network comprises an Ethernet network.

4. The method of claim 3, wherein the generating the transmission unit of the first type network comprises generating the transmission unit of the first type network by referring to a table in which the first type network address of the third device and the second type network address of the second device are mapped to a port of the first device of the first type network connected to the third device.

5. The method of claim 4, wherein the table is generated by transmitting, from the first device, a request message comprising information about the second type network address of the second device to devices connected to one another through the port of the first type network and by transmitting, from the third device, a response message, in response to the transmitted request message, to the first device.

6. The method of claim 5, wherein the request message is transmitted to devices of the first type network in a broadcasting manner, and the response message is transmitted by the third device to the first device in a unicast manner.

7. The method of claim 4, wherein the generating the transmission unit of the second type network comprises generating the transmission unit of the second type network in which a second type network address of the first device is set as a source address and the second type network address of the second device is set as the destination address.

8. The method of claim 7, wherein the generating the transmission unit of the first type network by referring to the table comprises generating the transmission unit of the first type network which comprises the generated transmission unit of the second type network and in which the first type network address of the first device is set as a source address and the first type network address of the third device is set as the destination address.

9. The method of claim 8, wherein the third device receives the transmitted transmission unit of the first type network from the first device and transmits the transmission unit of the second type network through a port of the second type network corresponding to the destination address of the transmission unit of the second type network.

10. A method of transmitting data to a first device of a first type network by using a second device, the method comprising:
generating a transmission unit of a second type network in which a second type network address of the first device is set as a destination address; and
transmitting the generated transmission unit of the second type network to a third device corresponding to the second type network address of the first device,
wherein the first device is not directly connected to the second type network.

11. The method of claim 10, wherein the third device generates a transmission unit of the first type network comprising the transmitted transmission unit of the second type network by setting a first type network address corresponding to the second type network address of the first device as a destination address and transmits the generated transmission unit of the first type network to the first device corresponding to the first type network address.

12. The method of claim 11, wherein the first type network comprises an audio/video (AV) network connected via a link that is capable of performing bidirectional transmission of audio/video (AV) data, and the second type network comprises an Ethernet network.

13. A method of relaying data by using a third device, the method comprising:
receiving, from a first device, a transmission unit of a first type network which comprises a transmission unit of a second type network in which a second type network address of a second device is set as a destination address and in which a first type network address of the third device is set as a destination address;
determining a port of the second type network to which the second type network address is mapped; and
transmitting the transmission unit of the second type network to the second device through the determined port of the second type network.

14. The method of claim 13, wherein the first type network comprises an audio/video (AV) network connected via a link that is capable of performing bidirectional transmission of audio/video (AV) data, and the second type network comprises an Ethernet network.

15. A method of relaying data by using a third device, the method comprising:
receiving, from a second device, a transmission unit of a second type network in which a second type network address of a first device is set as a destination address;
determining a port of a first type network to which the second type network address of the first device is mapped;
generating a transmission unit of the first type network in which a first type network address of the first device corresponding to the second type network address of the first device is set as a destination address and which comprises the received transmission unit of the second type network; and
transmitting the generated transmission unit of the first type network to the first device through the determined port of the first type network.

16. The method of claim 15, wherein the first type network comprises an audio/video (AV) network connected via a link that is capable of performing bidirectional transmission of AV data, and the second type network comprises an Ethernet network.

17. An apparatus for transmitting data to a second device by using a first device, the apparatus comprising:
a host unit which generates a transmission unit of a second type network in which a second type network address of the second device is set as a destination address; and
a port unit which generates a transmission unit of a first type network comprising the generated transmission unit of the second type network by setting a first type network address of a third device, corresponding to the second type network address of the second device, as a destination address, and which transmits the generated transmission unit of the first type network to the third device.

18. The apparatus of claim 17, wherein the third device transmits the transmission unit of the second type network to the second device corresponding to the second type network address.

19. An apparatus for transmitting data to a first device of a first type network by using a second device, the apparatus comprising:
a host unit which generates a transmission unit of a second type network in which a second type network address of the first device is set as a destination address; and
a port unit which transmits the generated transmission unit of the second type network to a third device corresponding to the second type network address of the first device,
wherein the first device is not directly connected to the second type network.

20. The apparatus of claim 19, wherein the third device generates a transmission unit of the first type network comprising the transmitted transmission unit of the second type network by setting a first type network address corresponding to the second type network address of the first device as a destination address and transmits the generated transmission unit of the first type network to the first device corresponding to the first type network address.

21. An apparatus for relaying data by using a third device, the apparatus comprising:
a first port unit which receives, from a first device, a transmission unit of a first type network which comprises a transmission unit of a second type network in which a second type network address of a second device is set as a destination address and in which a first type network address of the third device is set as a destination address;
a switch unit which determines a port of the second type network to which the second type network address is mapped; and
a second port unit which transmits the transmission unit of the second type network to the second device through the determined port of the second type network.

22. An apparatus for relaying data by using a third device, the apparatus comprising:
a second port unit which receives, from a second device, a transmission unit of a second type network in which a second type network address of a first device is set as a destination address;
a switch unit which determines a port of a first type network to which the second type network address of the first device is mapped; and
a first port unit which generates a transmission unit of the first type network in which a first type network address of the first device corresponding to the second type network address of the first device is set as a destination address and which comprises the received transmission unit of the second type network and which transmits the generated transmission unit of the first type network to the first device through the determined port of the first type network.

23. A computer-readable recording medium having recorded thereon a program for executing the method of claim 1.

24. A computer-readable recording medium having recorded thereon a program for executing the method of claim 10.

25. A computer-readable recording medium having recorded thereon a program for executing the method of claim 13.

26. A computer-readable recording medium having recorded thereon a program for executing the method of claim 15.
